(19) United States
(12) Patent Application Publication
(10) Pub. No.: US 2023/0385957 A1
(43) Pub. Date: Nov. 30, 2023

(54) SYSTEMS AND METHODS FOR USE IN IDENTIFYING TRIALS IN FIELDS

(71) Applicant: CLIMATE LLC, Saint Louis, MO (US)

(72) Inventors: Pei-Chen CHEN, Burlingame, CA (US); Moslem LADONI, Dublin, CA (US); Jacob MCDANIEL, O'Fallon, MO (US); Nicholas P. OCHS, Ellisville, MO (US)

(21) Appl. No.: 18/201,713

(22) Filed: May 24, 2023

Related U.S. Application Data
(60) Provisional application No. 63/346,115, filed on May 26, 2022.

(51) Int. Cl. G06Q 50/02; G06Q 10/0637

(52) U.S. Cl. CPC G06Q 50/02; G06Q 10/06375

(57) ABSTRACT

Systems and methods for use in identifying locations and/or sizes of trials in fields are provided. One example computer-implemented method includes defining a bounding box for a field based on a boundary line of the field and imposing multiple strips to the bounding box, where each strip has a dimension consistent with a desired planting pass for a trial in the field. The method also includes rotating the bounding box, with the strips, to an orientation consistent with a planting direction of the field and cropping the multiple strips consistent with one or more headlands of the field. The method then includes generating multiple candidate trials for the field, based on the multiple strips, calculating metrics for the candidate trials based on areas and shapes of the candidate trials, and selecting and publishing one or more of the candidate trials based on the metric as for implementation in the field.

### CROSS-REFERENCE TO RELATED APPLICATION

This application claims the benefit of, and priority to, U.S. Provisional Application No. 63/346,115, filed on May 26, 2022. The entire disclosure of the above application is incorporated herein by reference.

### FIELD

The present disclosure generally relates to systems and methods for use in identifying trials in fields (e.g., locations of trials within fields, locations for implementing trials in fields, etc.) and, more particularly, to identifying locations and/or sizes of such trials in target fields, for example, to promote accuracy of the trials as representative of the target fields.

### BACKGROUND

This section provides background information related to the present disclosure which is not necessarily prior art.

It is known for seeds to be grown in fields, by growers, for commercial purposes, whereby resulting plants, or parts thereof, are sold by the growers for business purposes and/or profit. In various instances, the growers may experiment with different variables as part of growing the seeds, for example, from seed selection to field treatments, in parts of the growers' fields, to provide bases to make changes to the seeds and/or the treatments used on various other parts of the fields. For example, a grower may plant a new variety of seeds in a portion of a field and/or apply a particular treatment to seeds planted in a portion of the field, as a change in his/her typical planting operation, where the older variety of seeds and/or the untreated part of the field act as a control for the change(s).

### SUMMARY

This section provides a general summary of the disclosure, and is not a comprehensive disclosure of its full scope or all of its features.

Example embodiments of the present disclosure generally relate to methods for use in identifying a location and/or a size of a trial in a target field. In one example embodiment, such a method generally includes accessing, by a computing device, for a target field, from a data server, a boundary line for the target field and an interval for planting passes for a trial in the target field; defining, by the computing device, a bounding box for the field based on the boundary line of the field, whereby the bounding box extends around the boundary line; imposing, by the computing device, multiple strips to the bounding box, each strip having a dimension consistent with the planting passes for the trial in the target field; rotating, by the computing device, the bounding box, with the strips, to an orientation consistent with a planting direction of the target field; cropping, by the computing device, the multiple strips consistent with one or more headlands of the target field; generating, by the computing device, multiple candidate trials for the target field, including multiple consecutive ones of the multiple strips; calculating, by the computing device, for each of the candidate trials, a metric based on one or more areas of said candidate trial; and selecting and publishing, by the computing device, one or more of the candidate trials, based on the metric, thereby identifying the one or more of the candidate trials as the location for said trial in the target field.

In another example embodiment, a method for use in identifying a location and/or a size of a trial in a target field generally includes accessing, by a computing device, for a target field, from a data server, data for a trial in the target field; generating, by the computing device, multiple candidate trials for the target field based on identification of multiple consecutive planter passes by a planter in the target field (e.g., via overlaying the planter passes on aerial imagery of the target field, etc.); calculating, by the computing device, for each of the candidate trials, a metric based on one or more areas of said candidate trial; and selecting and publishing, by the computing device, one or more of the candidate trials, based on the metric, thereby identifying the one or more of the candidate trials as the location for said trial in the target field.

Example embodiments of the present disclosure generally relate to non-transitory computer-readable storage media comprising executable instructions, which when executed by at least one processor, cause the at least one processor to identify a location and/or a size of a trial in a target field. In one such example embodiment, a non-transitory computer-readable storage medium comprises executable instructions, which when executed by at least one processor in connection with identifying a location and/or a size of a trial in a target field, cause the at least one processor to: access, for a target field, from a data server, a boundary line for the target field and an interval for planting passes for a trial in the target field; define a bounding box for the field based on the boundary line of the field, whereby the bounding box extends around the boundary line; impose multiple strips to the bounding box, each strip having a dimension consistent with the planting passes for the trial in the target field; rotate the bounding box, with the strips, to an orientation consistent with a planting direction of the target field; crop the multiple strips consistent with one or more headlands of the target field; generate multiple candidate trials for the target field, including multiple consecutive ones of the multiple strips; calculate, for each of the candidate trials, a metric based on one or more areas of said candidate trial; and select and publish one or more of the candidate trials, based on the metric, thereby identifying the one or more of the candidate trials as the location for said trial in the target field.

Further, example embodiments of the present disclosure generally relate to systems for use in identifying a location and/or a size of a trial in a target field. In one such embodiment, an example system includes an agricultural computer system configured to: access, for a target field, from a data server, a boundary line for the target field and an interval for planting passes for a trial in the target field; define a bounding box for the field based on the boundary line of the field, whereby the bounding box extends around the boundary line; impose multiple strips to the bounding box, each strip having a dimension consistent with the planting passes for the trial in the target field; rotate the bounding box, with the strips, to an orientation consistent with a planting direction of the target field; crop the multiple strips consistent with one or more headlands of the target field; generate multiple candidate trials for the target field, including multiple consecutive ones of the multiple strips; calculate, for each of the candidate trials, a metric based on one or more areas of said candidate trial; and select and publish one or more of the candidate trials, based on the metric, thereby identifying the one or more of the candidate trials as the location for said trial in the target field.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example system for identifying locations and/or sizes of trials in fields (e.g., in target fields, etc.);

FIG. 2 illustrates an example target field that may be included in the system of FIG. 1, in which an example trial, having three segments, is disposed;

FIGS. 3A-3D illustrate an example field and progressive bounding boxes (or boundaries) applied to the field, consistent with the configuration of the example system of FIG. 1;

FIGS. 4 and 5 illustrate example target fields, which include differing zone patterns, and trials disposed within the fields, whereby locations and/or sizes of the trials may be identified in connection with the system of FIG. 1;

FIG. 6 illustrates an example method of identifying a location and/or a size of a trial in a field, based on a candidate trial generated and assessed in connection with various data, where the method may be employed in connection with the system of FIG. 1;

FIG. 7 illustrates another example target field that may be included in the system of FIG. 1 and evaluated through the method of FIG. 6, and which includes a specific shape and example headlands;

FIG. 8 illustrates example trials generated for the target field in FIG. 7, where each of the example trials is associated with a metric, as calculated through the method of FIG. 6;

FIG. 9 provides a graphical illustration of deviation of example segments of a candidate trial generated herein through the system of FIG. 1 and/or the method of FIG. 6;

FIG. 10 depicts an example embodiment of a timeline view for data entry that may be generated and/or displayed in connection with the system of FIG. 1 and/or the method of FIG. 6;

FIG. 11 depicts an example embodiment of a spreadsheet view for data entry that may be generated and/or displayed in connection with the system of FIG. 1 and/or the method of FIG. 6;

FIGS. 12A-12B illustrate example logical organization of sets of instructions in main memory of a computing device when an example mobile application is loaded for execution;

FIG. 13 illustrates a programmed process by which the system of FIG. 1 and/or the method of FIG. 6 generates one or more preconfigured agronomic model(s) using agronomic data provided by one or more data source(s); and

FIG. 14 is a block diagram that illustrates an example computer system upon which embodiments of the system of FIG. 1 and/or the method of FIG. 6 may be implemented.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Trials may be imposed on fields in an attempt to understand, evaluate, etc. relative performance of particular varieties of seeds, of particular treatments, etc. in the fields, as compared to controls in the same fields (e.g., different varieties of seeds, different treatments, different rates of treatments, different timings of treatments, different concentrations of treatments, etc.). The trials may be placed at limited, optimal positions in the fields, for example, by growers, whereby results of the trials may be indicative of the performance thereof at the given, specific positions (e.g., based on yield, etc.), but not generally representative of performance across the entire fields. In connection therewith, the trials may relate to planting seeds in the fields, applying treatments to existing crops in the fields, irrigating crops in the fields, etc.

Uniquely, the systems and methods herein provide for locating trials (e.g., identifying locations of the trials, sizes of the trials, field locations for experimental placement of trials based on prediction models, etc.) in fields, which improves accuracy of the trials as indicative of performance of variations in the trials, generally, in the fields. In particular, an agricultural computer system is configured to generate one or more candidate (e.g., candidate, synthesized, etc.) trials for a target field, based on, for example, a boundary line, headlands, machinery traversals, and/or a planting direction, etc. associated with the field. The candidate trial(s) is(are) then assessed, based on shape, area, and/or relative yield of the candidate trial(s), whereby the candidate trial(s) is(are) ranked and/or selected. The selected candidate trial(s) is(are) then implemented in the target field to promote improved accuracy in the trial, as to the target field as a whole (e.g., seeds are planted in the field in accordance with the selected candidate trial(s), etc.). As such, the systems and methods herein provide for improved accuracy of trials in target fields, for example, as applied across entireties of the fields.

Moreover, the trial(s) may be generally selected to represent the target field in terms of potential yield outcome. Additionally, and as described in more detail herein, control and treatment areas within the trial may be located to cover (or involve) ground with similar yield potential. This allows the section of the field designated for the trial (and other trials across entirety of the field) to have similar pre-treatment conditions, which in turn allows for more accurate measurement (and/or isolation) of the effect of the treatment, etc. implemented in the trial(s), and for generalizing the same to the rest of the field. In this manner, the trial(s) may be implemented in the target field to determine potential effect (e.g., preferably yields, but also disease occurrence, or other phenotypic features, etc.) of one or more different variants provided in the trials (e.g., seed variations, treatment variations, irrigation variations, tillage variations, etc.) where the effect identified in the trial, in turn, is representative of the one or more different variants (and not representative of differences in the section of the field designated for the trial).

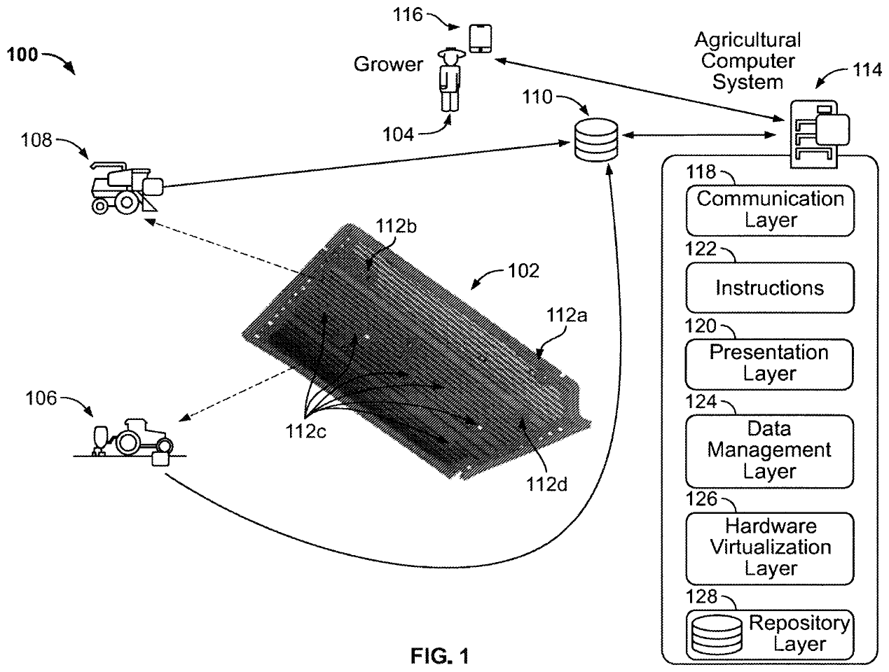

FIG. 1 illustrates an example system 100 in which one or more aspect(s) of the present disclosure may be implemented. Although the system 100 is presented in one arrangement, other embodiments may include the parts of the system 100 (or other parts) arranged otherwise depending on, for example, relationships between users, farm equipment and fields, data flows, types of plants included in fields, types and/or locations of fields, numbers and/or types of trials, planting and/or harvest activities in the fields, privacy and/or data requirements, etc.

As shown in the embodiment of FIG. 1, the system 100 generally includes a field 102 (broadly, a growing space) in which seeds/plants are planted, grown and harvested (e.g., by grower 104, etc.). It should be appreciated that the field 102 is provided for illustration, and that systems consistent with the present disclosure often includes dozens, hundreds or thousands of fields, or more or less, etc., each of which may be subject to the description herein.

In general, in this example, the field 102 is owned by the grower 104, which is in the business of planting, growing, and harvesting crops, over a period of various seasons. In other examples, the grower 104 may not actually own the field 102 but may still be associated with planting, growing, and/or harvesting seeds/plants in the field 102.

In connection therewith, the grower 104 provides for certain farm equipment to be used for planting, growing, treating, and harvesting a crop, etc. in the field 102. In this example embodiment, the system 100 includes a planter 106 and a harvester 108. The planter 106, for example, is configured to dispense seeds into the field 102 in a particular manner (e.g., in a particular pattern such as in lines, at a particular rate, etc.) over a swath of the planter 106, whereby multiple rows are planted at one time. And, the harvester 108 may include, for example, a combine, a picker, or other mechanism for harvesting plants/crops from the field 102. The harvester 108 may be automated, or reliant, at least in part, on a human operator, etc. The harvester 108, in general, is configured to remove a part of a plant grown from the planted seeds (e.g., an ear of corn, beans from soybeans, grain from wheat, etc.), which is referred to herein as harvesting. The harvester 108 may additionally, or alternatively, perform operations including picking, threshing, cutting, reaping, gathering, etc.

It should be appreciated that other farm equipment may be used in the field 102 (and more generally, in the system 100), including, for example, a sprayer (not shown), which is configured to apply one or more treatments to the crops in the field 102, prior to planting, after planting and/or prior to harvest of the crop. Still other equipment may be employed in the field 102 and configured to perform operations related to the planting, growing or harvesting of the crops therein.

As part of the above, the farm equipment (e.g., the planter 106, the harvester 108, etc.) is configured to collect data and to transmit the data to data server 110. For example, the planter 106 is configured to compile data specific to at least planting. The data may include, without limitation, seed type/name, seed/row position, location data, planting rate, planting direction, time/date data, or other suitable data, etc. The planter 106 is configured to collect and transmit the planting data to the data server 110. Similarly, the harvester 108 is configured to compile/collect data specific to the plant(s) being harvested and to the operation of harvesting of the plant(s), etc. The data may include, without limitation, location of the field 102 and/or plants (e.g., as expressed in latitude/longitude or otherwise, etc.), yield, weight, moisture content, volume, flow, time/date data, or other suitable data, etc. The harvester 108 is configured to transmit the gathered data to the data server 110.

It should be appreciated that further farm equipment may be included in the field 102, that may also be configured to collect and transmit data to the data server 110. It should be further appreciated that data about the field 102 and/or crop in the field may be compiled and/or collected, and also transmitted to the data server 110, in whole or in part, independent of the farm equipment. For example, certain data related to the field 102, such as, for example, boundary lines, may be defined by the grower 104 and transmitted to the data server 110.

Further, in various embodiments, the data collected by the farm equipment (e.g., the planter 106, the harvester 108, etc.) and/or data collected otherwise, and transmitted to and/or included in the data server 110, may further include, for example, boundary line data for the field 102 (and/or other fields) and direction data for crop(s) in the field 102, etc. In addition, headland data for the field 102 (and/or for other fields) may be included in the data server 110, for example, as generated based on such data collected by the farm equipment, etc.

In particular, for example, the field 102 is defined by a boundary line, which traces an outside edge of the field 102, and serves to distinguish the field 102 from other fields, and specifically, neighboring fields. The boundary line may be defined by a legal border, structures (e.g., roads, railroad tracks, etc.), water ways (e.g., rivers, ditches, canals, etc.), or otherwise, etc. It should be appreciated that in some examples the boundary line of the field 102, for example, may be defined by a grower to separate contiguous land owned/operated by the grower into more than one field. Consistent with the above, the boundary line for the field 102 is defined by coordinates (e.g., as defined by the grower 104 and/or captured by farm equipment, etc.), which is stored in the data server 110.

In addition, the field 102 includes parts, areas, regions, portions, etc. which are designated as headlands 112a-d. Each of the headlands 112a-d is generally a strip or segment or portion of land in the field 102 that is planted with seed and generally borders unplanted regions, but which has operational abnormalities that could hinder the plants ability to perform. The headlands 112a-d may include, for example, areas of the field 102 that are driven over during planting, driven over due to a turn radius of farm equipment in the field 102 (e.g., the planter 106, etc.), or driven around due to an obstacle in the field 102 (e.g., standing water, utilities, trees, rocks, etc.) thereby resulting in such operational abnormalities, etc. The headlands 112a-d may be designated, measured and/or determined based on data received by and/or from farm equipment (e.g., the planter 106, the harvester 108, etc. as shown in FIG. 1, or otherwise; etc.) used in the field 102 to plant, harvest or otherwise interact with the field 102. Additionally, or alternatively, the headlands 112a-d may be estimated, for example, as a threshold distance from a boundary line and/or missing data for the field 102. For example, the headlands 112a-d may be defined as a two swath width of farm equipment (e.g., the planter 106 shown in FIG. 1 (e.g., 60 feet, or more or less, etc.), etc.) from the boundary line of the field 102. Similarly, for example, an obstacle in the field 102, such as, for example, a rock, a tree, etc. may prevent planting in that part of the field 102 by the planter 106, whereby planting data for that part of the field 102 is absent. As such, the absence of data for a part of the field 102, for example, may be understood as an obstacle in the field 102 (or a headland, more generally), whereby the two swath width may again be applied to define the headland associated with the obstacle. It should be appreciated that headlands within the center of a field, or apart from the boundary line, may be considered, or omitted, in various embodiment herein.

Regardless, as shown in FIG. 1, the headlands 112a-d of the field 102 are included in or as a darker, solid shaded area in the illustrated embodiment, around the perimeter of the field 102 and also within the field 102. Data indicative of the headlands 112a-d is also stored for the field 102 in the data server 110.

Moreover, in planting or harvesting of the field 102, the farm equipment, such as, for example, the planter 106 included in the system 100, is configured to traverse the field 102 to plant seeds within the field 102 (or, for the harvester 108, to harvest crops). In doing so, movement of the planter 106, for example, defines a direction of planting, or a planting direction. The planting direction is generally the direction of the planting swaths (or paths, etc.) of the planter 106 (as indicated by the generally parallel lines included in the field 102 in FIG. 1). The planting direction may be different for different parts of the field (not shown), whereby multiple patches may be defined in the field 102 where each patch includes a consistent planting direction (e.g., a consistent direction of planting swaths, etc.). Further, it should be appreciated that the planting direction may be generally consistent with the harvest direction, whereby when a planting direction is not specifically known for the field 102, the harvest direction (e.g., based on movement of the harvester 108, etc.) may be used as an estimate, or in place, of the planting direction described below. Further still, the planting direction generally indicates the direction of rows of crops within the field 102. As such, the planting direction may be determined from remotely sensed or captured images of the field 102, for example, where crop lines generally define the planting direction. Like the other data herein, the planting direction (and harvest direction) of the field 102 is stored in the data server 110.

In view of the above, the data server 110 is configured to store the data received from the farm equipment, remotely sensed, or otherwise captured and/or received, in one or more data structures. In general, in this example embodiment, the data server 110 is configured to store data by year (e.g., Year_X, Year_X+1, etc.), which corresponds to different growing years of crops in the field 102 (and other fields). Then, for each year, the data structure(s) will include the above described data for each of the desired fields (e.g., including the field 102, etc.), etc.

That said, in general in the system 100, the grower 104 desires to enhance performance of the crops planted in the field 102. A higher yield, for example, may provide a greater commercial benefit of the field 102. As such, from time to time, the grower 104 may decide to alter one or more conditions of the field 102, for example, as to the type/variety of seeds planted or as to the growing conditions as the seeds grow into plants (e.g., through treatments, irrigation, etc.), and then harvest the crops to determine the success of the alteration(s). Implementing such alteration(s) is generally referred to herein as a trial (or trials). In connection therewith, the trial may be defined to include or involve (without limitation) one or more of the following example aspects, or any combination thereof: one or more treatments or combination of treatments (e.g., fertilizer, herbicide, insecticide, fungicide, etc.), one or more different types of seeds (e.g., types, varieties, etc.), one or more different irrigation settings and/or schedules, planting seeds at one or more different seeding and/or planting rates, different tillage, one or more different mechanical settings of equipment (e.g., downforce, seeding depth, closing wheels, etc.), etc. Further, the trial may be defined by the grower 104, or may be designed by a provider of the seeds and/or the treatment(s), or a combination of both, etc.

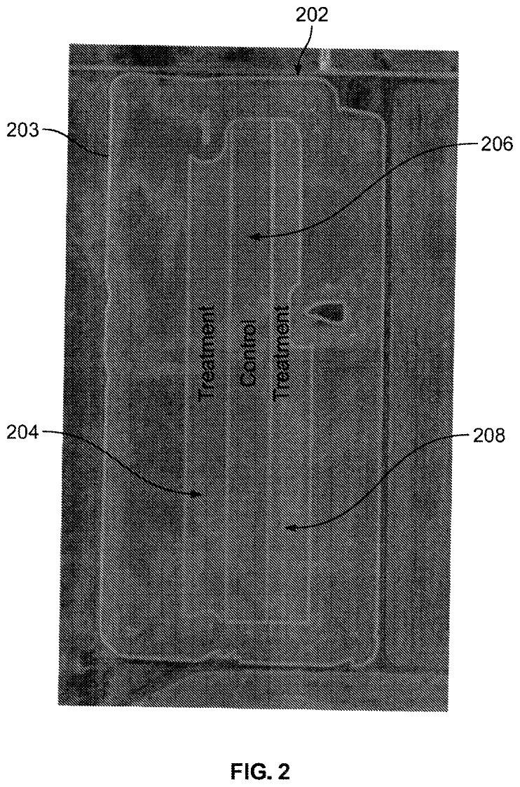

FIG. 2 illustrates an example target field 202, which covers a number of acres and which includes a trial. The trial is illustrated within the boundary line 203 of the field 202, and includes three strips: a first treatment or test strip 204, a control strip 206, and a second treatment or test strip 208. In this manner, the trial in FIG. 2 forms a triplet of consecutive strips (e.g., adjacent strips, etc.), where the adjacency of the consecutive strips 204-208 promote direct comparison of the test and the control. While the strips 204-208 are illustrated in an arrangement of test-control-test in FIG. 2, it should be appreciated that the trial may include strips designated or arranged otherwise in other embodiments, for example, control-test-control, test-test-control, control-test-test, etc. It should be understood that a strip may include, for example, an area, which is contained within the target field 202 and defines any suitable shape.

Referring again to FIG. 1, when the trial is defined, a location of the trial in the field 102 (e.g., for potentially implementing the trial in the field 102, etc.) is determined by the system 100, as described below. In particular, in this example embodiment, the system 100 includes an agricultural computer system 114, which is programmed, or configured, to access the data in the data server 110 and to determine a location in the field 102 and/or a size within the field 102, for example, of a trial (e.g., of the defined trial, etc.). The size of the trial may be sufficiently large and/or the trial itself may be sufficiently representative of the field 102, whereby the determinations herein may be attributed to the field 102 in some examples.

In connection therewith, the agricultural computer system 114 is configured to generate a series of candidate trials for the field 102 (as options for the actual trial in the field 102, etc.). As will be described, the candidate trials may each be generated based on actual planter passes through the field 102 (e.g., for seed planting trials, etc.) or based on synthetic (or synthesized) passes through the field 102 (or, potentially, based on combinations thereof). A candidate trial may be based on actual planter passes in instances where the field 102 (or portion of the field 102 being evaluated) is generally continuous and not interrupted by headlands, etc. (whereby the actual planter passes in planting the field may be determined). Alternatively, a candidate trial may be based on synthetic passes in instances where the field 102 has relatively low placement success rates due to misidentification of headlands due to lower quality data, etc. In connection therewith, in various examples, the passes (either actual or synthetic) are consistent with movement of farm equipment through the field 102, for example, for planting seeds, applying treatments, etc. As such, the passes may be generally straight in arrangement (e.g., where multiple passes are generally parallel, etc.), or the passes may be curved (e.g., where the passes may be generally rounded and/or spiral, etc.), or combinations thereof. Such arrangement of the passes may depend on the layout or shape of the field 102, the presence and/or location of headlands 112a-d in the field 102, the particular farm equipment, etc.

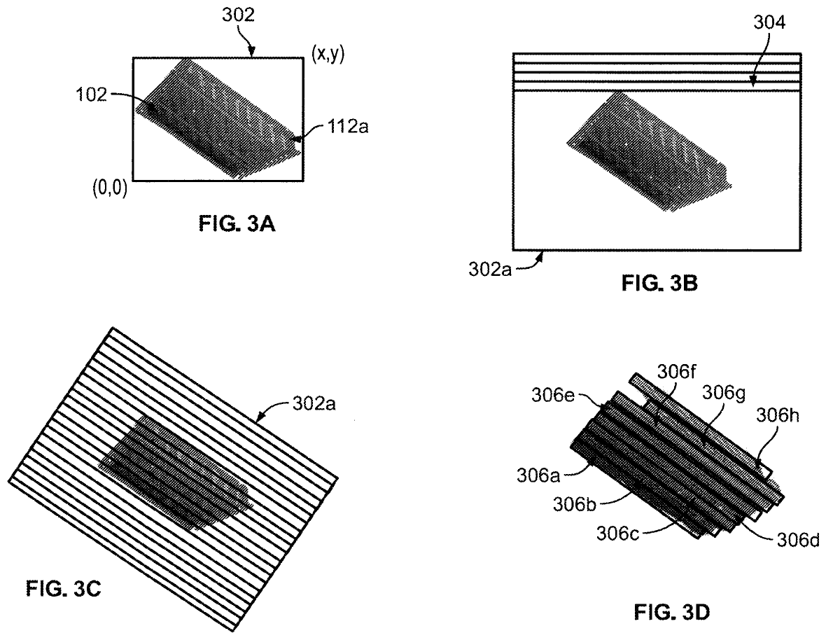

In this example, the candidate trials are generated based on synthetic (or synthesized) passes through the field 102. In doing so, the agricultural computer system 114 is configured to initially identify the boundary line of the field 102 and to assign a bounding box (or, more generally, a boundary or bounding region) to the field 102, which extends around the boundary line. The bounding box includes, in this example (and without limitation) a rectangular shape, and includes the entire field 102 (however, this is not required in all implementations). The generated trials may then be identified in the field 102 within or via the bounding box, as described more hereinafter. FIG. 3A illustrates an example bounding box 302 for the field 102. The bounding box 302 generally defines a maximum length and a maximum width. For example, where a right lower corner of the bounding box is at coordinates (0, 0), the right upper corner of the bounding box is at coordinates (x, y), where x is the maximum width of the bounding box 302 and y is the maximum length of the bounding box 302. While reference is made to a bounding box in this example, it should be appreciated that in other embodiments the boundary (or boundary region) defined thereby may have shapes other than a box, for example, triangular shapes, pentagon shapes, octagon shapes, other polygon shapes, shapes other than polygons, etc.

In addition in the system 100, the agricultural computer system 114 is also configured to identify an interval of the trials (e.g., for planting traversals or planting passes in the field 102, etc.). The interval may include a multiple of the swath width of the farm equipment used in the field 102 (e.g., the planter 106 for seed planting trials, etc.), or the interval may be selected by the grower 104 or another user associated with the grower 104 or the field 102 or the interval may be selected in association with the seeds/treatment(s) to be applied to the field 102 (e.g., taking into account spraying width of a sprayer, etc.), etc. That said, the interval may be, without limitation, for example, thirty feet, sixty feet, one hundred twenty feet, or more or less, etc.

Next in the system 100, the agricultural computer system 114 is configured to expand the bounding box assigned to the field 102.

In the example of FIG. 3A, the bounding box 302 is increased in area by three times, which is shown in FIG. 3B, for example, as the expanded bounding box 302a. In this manner, if/when the expanded bounding box 302a is rotated in a later operation, by the agricultural computer system 114, the bounding box 302a continues to cover the field 102. As such, it should be appreciated that the bounding box 302 may be expanded by other factors to provide for sufficient coverage of fields in other system embodiments (e.g., by two times, by two and a half times, by three and a half times, etc.).

With continued reference to the example of FIG. 3B, after expanding the bounding box 302a, the agricultural computer system 114 is configured to then populate (or synthesize) strips (e.g., representative of synthetic planter passes in the field 102 (or passes of other farm equipment), etc.) into the expanded bounding box 302a. The strips define a width consistent with the interval of the trial identified above (e.g., consistent with an application width, a swath width, a width in general, etc. of the farm equipment; etc.). The strips are illustrated in FIG. 3B, and referenced 304. While only four strips 304 are shown in FIG. 3B, for purposes of illustration, it should be appreciated that at this stage the expanded bounding box 302a is fully populated from edge to edge with strips 304. Additionally, the agricultural computer system 114 is configured to populate the strips 304 generally in the long direction (or long dimension) of the expanded bounding box 302a in this example, but may populate the strips in a different direction in another example. For example, the agricultural computer system 114 may be configured to populate the strips in an orientation intended to be consistent with the planting direction (or direction of planting or harvesting) for the field 102 (as described next) (which may, in some examples, permit omission of expanding the bounding box 302). In addition, a length of the strips generally correspond to the size of the bounding box 302a (as expanded).

After populating the strips 304 in the expanded bounding box 302a, the agricultural computer system 114 is configured to rotate the expanded bounding box 302a (along with the imposed strips 304) to align the strips with the planting direction of the field 102 (e.g., with the planting passes in the field 102 (e.g., the actual planting passes, the synthesized planting passes, etc.), as shown in FIG. 3C, for example. In order to compute the accurate rotation angle, a direction of planting polygons is computed on the same planar coordinate system as the strips. The strips are then rotated based on the computed angle from the planting polygons and around the center of expanded grid/box. This will ensure that the strips are along the exact same direction of planting polygons on the planar coordinate system. The agricultural computer system 114 is configured to then crop the strips 304 consistent with the headland 112a of the field 102 (and potentially also the headlands 112b-d), whereby only the parts of the strips in the field 102 and outside of the headland 112a are retained (e.g., the strips 304 are cut down (or reduced in size, etc.) to match the general shape/boundary/size of the field 102, for instance, consistent with the headlands 112a-d of the field 102; etc.). As shown in FIG. 3D, eight cropped strips 306a-h are provided (or remain) in this example.

It should be appreciated that FIGS. 3A-3D are provided for purposes of illustration only, and should not be understood to limit the specific shape and/or orientation of fields, strips, and/or bounding boxes, etc. herein.

Once the cropped strips for the field 102 are defined, the agricultural computer system 114 is configured to generate a candidate trial (or multiple candidate trials) for the field 102. In this example embodiment, each candidate trial includes three cropped strips or a triplet, which includes either a test strip, a control strip, and a test strip, or a control strip, a test strip, and control strip, generally. In this manner, as suggested above, the similarity of the field 102 in the adjacent strips is leveraged to enhance accuracy of any results of the given candidate trial. As such, the agricultural computer system 114 is configured to generate the given candidate trial (and other candidate trials for the field 102) starting from a start strip (e.g., strip 306a in FIG. 3D, etc.), where the first three consecutive strips (or first three adjacent strips, etc.) then are a first candidate trial, and then stepping to the next strip after strip 306a to generate a next candidate trial (including the next three consecutive strips), and so on until the last strip is included in a final candidate trial (e.g., strip 306h in FIG. 3D, etc.). Consequently, in this example embodiment, where the field 102 includes the eight cropped strips 306a-h (FIG. 3D), the agricultural computer system 114 generates six candidate trials as illustrated, for example, in Table 1, with each candidate trial including three consecutive strips from the field 102.

TABLE 1

| Trial | Strips |
|---|---|
| 1 | 306a, 306b, 306c |
| 2 | 306b, 306c, 306d |
| 3 | 306c, 306d, 306e |
| 4 | 306d, 306e, 306f |
| 5 | 306e, 306f, 306g |
| 6 | 306f, 306g, 306h |

In the above example, the candidate trials in the field 102 are defined based generally on strips populated into a bounding box fit to the field 102. In doing so, the strips generally represent synthetic (or synthesized) planter passes through (or across) the field 102. On this point, again, it should be appreciated that the candidate trials may be defined in this manner, or they may instead be defined based on actual planter passes through the field 102 (e.g., with or without using a bounding box, etc.). Synthetic planter passes, for example, may be used (or recommended) in instances for fields having low placement success rates due to headlands separating the passes, etc. As described above, in generating the candidate trials based on such synthetic planter passes, a planting direction and planter swath width within the field 102 may be used to create the synthetic passes (e.g., the strips populated in the bounding box, etc.), as attempting to realize the actual planter passes may be difficult and/or inaccurate due to the headlands, poor data quality, etc. Alternatively, actual planter passes may be used, for example, in instances where the passes are generally continuous and not interrupted by headlands, etc. (and therefore may be readily defined across the field 102 without interruption, etc.). In doing so, the actual planter passes in the field 102 may be identified, defined, etc., for example, by overlaying the planter passes on aerial imagery of the field 102, etc., and then used as the basis for generating the candidate trials.

Once generated (be it via use of synthetic planter passes or actual planter passes), the agricultural computer system 114 is configured to evaluate each of the candidate trials. In particular, for example, the agricultural computer system 114 is configured to estimate the candidate trials' representation of the field 102, as a whole. In connection therewith, the agricultural computer system 114 is configured to filter out one or more of the trials, for example, in which a difference in target yield between the test strip(s) (or passes) associated with the trials and the control strip(s) (or passes) associated with the trials is below a certain threshold (e.g., abs(control_target_yield−test_target_yield)<yield threshold; etc.). The respective target yield may include a predicted yield for the test strips and control strips, or the respective target yield may include a potential yield for the test strips and control strips. The target yield may be computed for every location in the target field 102, for example, by clustering vegetation indices computed on prior years satellite imagery and/or historical yield data. And, the yield threshold may be set or defined as desired, for example (and without limitation), at (or as) about one bushel per acre (1 bu/ac) for corn plants and soybeans plants, etc. (e.g., based on historical data, etc.), or as another value. That said, in other example embodiments, the yield threshold may be set otherwise depending on the particular plants in the field and/or other data available relative to the field, for example, less than one bushel per acre, more than one bushel per acre, etc. (e.g., about 0.5 bushels per acre, about 1.5 bushels per acre, about 2 bushels per acre, etc.)

The agricultural computer system 114 may also be configured to filter out certain ones of the trials in which a combination of grower seeding rates and seeding thresholds is greater than a treatment seeding rate (e.g., a defined or predefined treatment seeding rate, etc.) (e.g., grower_seeding_rate+seed_threhold>treatment_seeding_rate; etc.). In some examples, the seeding threshold may be computed to be about 5% of an average seeding rate in the target field 102 (e.g., based on historical data, etc.). And, any seeding rate difference larger than (or exceeding) the 5% threshold may have a measurable impact on yield (such that the corresponding trial is filtered out or removed). Therefore, the seeding threshold filter may provide for selection (or filtering or removal) of only the trials that have enough seeding rate difference between the control (e.g., the grower seeding rate, etc.) and the test/treatment (e.g., the treatment seeding rate, etc.), so as to allow for observing and measuring the yield difference.

Next, the agricultural computer system 114 is configured to select a number of the trials remaining based on similar target yield (e.g., based on yield zones for the trials, etc.), as compared to the field 102. For example, the distribution of target yields (e.g., zones of target yields, etc.) may be compiled for the field 102 and also for each of the trials, and the two distributions may then be compared using the Kolmogorov—Smirnov statistic. The more similar the given trial is to the field 102 (based on such target yields, or target yield zones, etc.) the smaller the Kolmogorov—Smirnov statistic. The trials that are most similar to the rest of the field 102 may then be carried forward in the selection process. That said, it should be appreciated that other statistical tests may be used to effect the comparison of the distributions in other example embodiments.

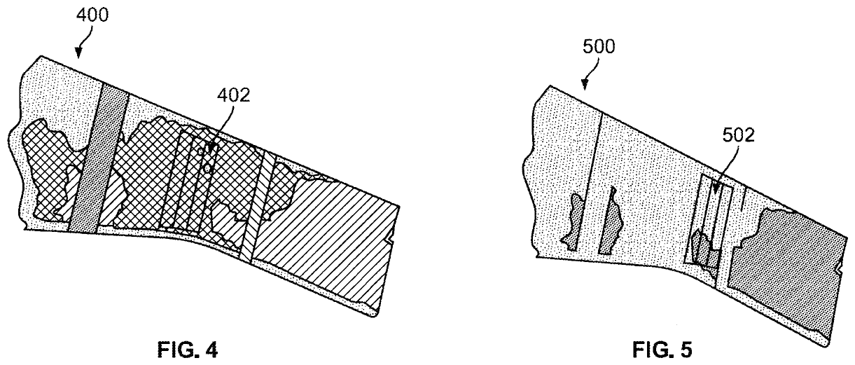

FIGS. 4-5 illustrate example target fields 400, 500, which may be included in the system 100 of FIG. 1. As shown, the target fields 400, 500 have different zones (or regions), each of which is represented by different hatching/coloring. For instance, the target field 400 includes five different zones, and the target field 500 includes two different zones. The different zones may be based on (or identified based on, or determined based on, etc.) target yield, planting rate, or other historical data, whereby different parts (or zones) of the target fields 400, 500 are understood to perform differently. By comparison, the zones in the target field 400 of FIG. 4 are more disparate or irregular, as compared to the target field 500 of FIG. 5. As such, when a trial 402 is randomly applied to the target field 400, the trial 402, as shown, is generally limited to one zone, and thereby would not be representative of the performance of the field 400 overall. Conversely, the trial 502 applied to the target field 500 includes aspects of the two zones represented in the target field 500, and thus, provides an improved representation of the field 500 (at least to the parameter upon which the zones are applied (e.g., yield, planting rate, etc.)), as compared to the trial 402 in the field 400.

With further reference again to the system 100 of FIG. 1, in this example embodiment, after selecting certain ones of the trials, the agricultural computer system 114 is configured to rank the selected trials based on trial shape and relative area. In doing so, for each of the trials, a further bounding box (or boundary) is imposed on the specific trial. For example, the agricultural computer system 114 may be configured to impose a minimum rectangle (as a bounding box or boundary) that fits the trial (e.g., that extends around the trial, that otherwise fits the trial, etc.) while potentially intersecting a trial boundary line of the trial (but without the trial extending beyond the minimum rectangle). The minimum rectangle, in this example, is defined as the minimum rectangle that can fit the trial, similar to the bounding box described above (e.g., similar to the bounding box 302, etc.), and generally defines an area. The agricultural computer system 114 is then configured to identify a preferred trial based on comparison of the imposed minimum rectangles (or bounding boxes, etc.) on each of the trials.

In particular, in this embodiment, the agricultural computer system 114 is configured to calculate a shape ratio for each of the candidate trials based on the minimum rectangle (or bounding box) fit to the trial, as defined by Equation (1) below. As shown, the shape ratio, SR, is based on the area of the specific trial (where i represents the number of the trial, for example, trial 1, trial 2, trial 3, etc.) divided by the area of the minimum rectangle (or bounding box) fit to (or fit for) the specific trial.

$$ShapeRatio ( SR ) = \frac{{TrialArea}_{i}}{{TrialBoxArea}_{i}} \qquad ( 1 )$$

It should be appreciated that the above expression may be modified and/or different in other embodiments. For example, the bounding box may be applied to a control strip and a test strip of the trial (rather than the entire trial), and then the area of the test strip and control strip is divided by the area of the bounding box in the expression above. To be clear, the expression of the shape ratio is not limited to the expression above.

In addition, in this embodiment, the agricultural computer system 114 is configured to also calculate a relative area ratio for each of the trials, which is defined below. As shown by Equation (2) below, the relative area ratio, RAR, is based on the area of the control (CntAreaᵢ) and half the area of the test (or tested area or treated area) of the specific trial (TrtAreaᵢ) (where i represents the number of the trial, for example, trial 1, trial 2, trial 3, etc.) (as the RelativeAreaᵢ)(e.g., where the test is two strips and the control is one strip, etc.) divided by the maximum value among all relative areas generated from the trials within the target field 102 (as Equation (2)).

$${RelativeArea}_{i} = {CntArea}_{i} + 0.5 \cdot {TrtArea}_{i} \qquad ( 2 )$$

$$RelativeAreaRatio ( RAR ) = \frac{{RelativeArea}_{i}}{max ( {RelativeArea}_{i} )}$$

The agricultural computer system 114 is configured to then combine the shape ratio, SR, and the relative area ratio, RAR, as defined by Equation (3) below, to provide a combined shape and area metric, for each of the candidate trials. The combined shape and area metric, accordingly, is defined to penalize the candidate trials, where either of the shape or relative area ratios is too small.

$$Metric = \frac{2 \times ( RAR \times SR )}{( RAR + SR )} \qquad ( 3 )$$

Then, the agricultural computer system 114 is configured to rank the trials based on the combined shape ratio and relative area ratio metric, and to select one or more of the trials based on the ranking. The agricultural computer system 114 is configured to store the one or more selected trials in the data server 110, and to report the one or more selected trial to the grower 104 and/or otherwise in order to implement the trial(s).

From there, the agricultural computer system 114 may be configured, for example, to identify a desired number (e.g., 3, 4, 5, 6, 7, 8, 10, etc.) of highest ranking ones of the stored candidate trials (e.g., where the metric for each of the identified trials is above a desired threshold (e.g., 0.4, 0.5, 0.6, 0.7, 0.8, 0.9, higher thresholds, lower thresholds, etc.), etc.). And, the highest ranking trial of those identified may then be marked, identified, tagged, classified, designated, etc. as the selected candidate trial, while the other identified trials may be marked, identified, tagged, classified, designated etc. as qualified candidate trials.

The agricultural computer system 114 may be configured to then publish the selected candidate trial and/or one or more of the qualified candidate trials, for example, as the location for said trial in the target field 102 (e.g., to the grower 104, to other parties, etc.). And, the published trial(s), as made available to the grower, for example, may then be implemented in the target field 104 by the grower 104. For example, the grower 104 may plant seeds in the field 102 in accordance with one or more of the published candidate trial(s) (e.g., by planting seeds at the location(s) indicated by the candidate trial(s), treating the field 102 and/or seeds in accordance with the trial(s), harvesting the seeds in accordance with the trial(s), etc.), to promote improved accuracy in the trial, as to the target field 102 as a whole.

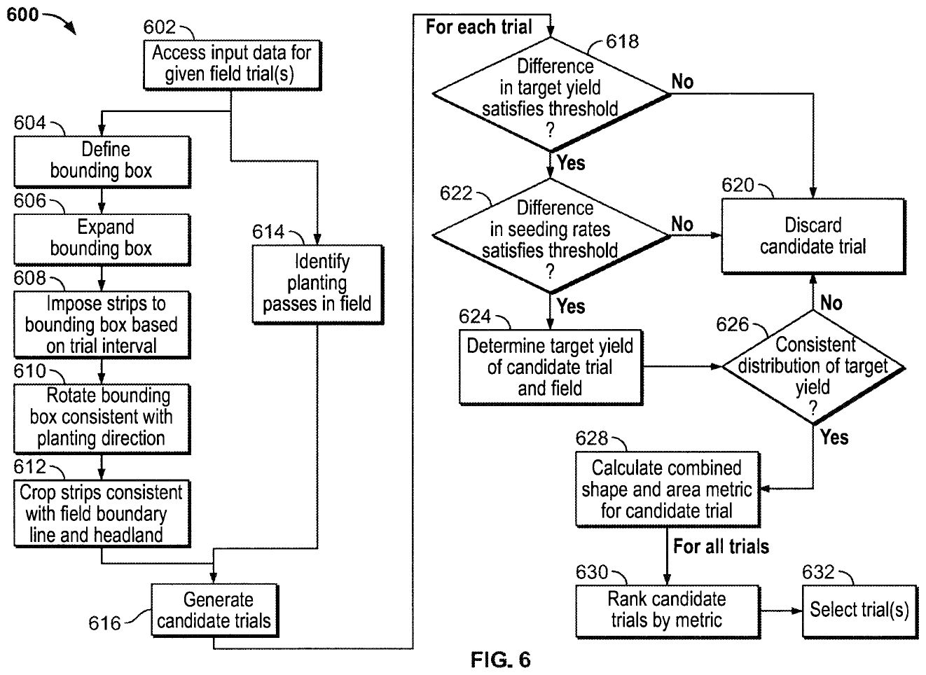

FIG. 6 illustrates an example method 600 for identifying a size and/or location of a trial in a target field. The example method 600 is described herein in connection with the system 100, and may be implemented, in whole or in part, in the agricultural computer system 114 of the system 100. However, it should be appreciated that the method 600, or other methods described herein, are not limited to the system 100 or the agricultural computer system 114. And, conversely, the systems, data servers, and the computing devices described herein are not limited to the example method 600.

At the outset, it should be appreciated that data is stored in the data server 110 for the field 102, where the data is indicative of the features of the field 102 and prior use of the field 102 for planting, growing and harvesting of crops. As explained above, the data may be indicative of crops in the field 102, of the boundary line of the field 102, the headlands 112a-d of the field 112, the planting direction (or harvest direction) of the field 102 (or images of the field 102 after planting, etc.), yield data for the field 102, prior planting plans for the field 102 (e.g., seed types, seed rate, predicted yield, etc.), etc.

Initially in method 600, the agricultural computer system 114 accesses, at 602, the data in the data server 110, and specifically, the planting direction for the field 102 and the boundary line of the field 102. In addition, the agricultural computer system 114 may further access headland data for the headlands 112a-d, if available. Also, the agricultural computer system 114 may access an interval for the trial, which defines a width of the trial. For example, where an interval is thirty feet, and is part of a triplet, the trial width is ninety feet, which includes thirty feet of type A, thirty feet of type B and thirty feet of type A, where type A is the test or the control, and type B is the other of the test and control. The interval may be defined per segment, or for the entire trial, as desired. In the example of FIG. 6, the interval defines the width of each segment of the trial. Other data accessed from the data server 110 may include target yield data, rates, thresholds, etc.

It should be appreciated that data may also be accessed from the data server 110, at the outset of the method 600, or in connection with specific steps of the method 600 for which the data is relevant.

In connection therewith, the agricultural computer system 114 then proceeds to generate multiple candidate trials for the field 102 (as options for the actual trial(s) in the field 102, etc.). As described above in the system 100, the candidate trials may each be generated based on synthetic (or synthesized) planter passes through the field 102 or they may be based on actual planter passes through the field 102.

In generating the candidate trials based on synthetic planter passes through the field 102, for example, the agricultural computer system 114 determines (and/or defines), at 604, a bounding box for the field 102. The bounding box, for example, may be defined as a rectangle overlaid on the field 102, where the bounding box is of sufficient size that no part of the field 102 extends beyond the bounding box. In other words, the bounding box is sized to bound the field 102 therein. It should be appreciated that the size of the bounding box may further be based on the interval of the trial, for example, to permit an integer number of strips consistent with the interval to be imposed on the bounding box (e.g., as determined, or as expanded, as indicated below, etc.). In this example embodiment, the bounding box is defined without reference to the orientation of the field 102, or the planting direction within the field 102. Yet, it should be appreciated that, in other embodiments, the bounding box may be determined with reference to a long axis of the field, a planting direction, or other data that may permit the bounding box to more closely, or less closely, align with the field, for various reasons. Furthermore, the shape of the bounding box may be otherwise, in other method embodiments, which may in turn, potentially, depend on the types and shapes of fields for which the trial are to be located.

After the bounding box is determined, the agricultural computer system 114 expands, at 606, the bounding box. In this example embodiment, the bounding box is expanded by a multiple of three, whereby the area of the bounding box is tripled. It should be appreciated that the bounding box may be expanded otherwise by a multiple of two, four, five, six, or more or less. Generally, in this example, however, the bounding box is expanded in a manner sufficient to allow for the field 102, for example, to continue to be bounded by the box when rotated. It should be appreciated that the shape of the bounding box may also be pertinent to the degree of expansion, whereby, for example, a square bounding box may be expanded less than rectangular bounding box.

In at least one embodiment, expanding the bounding box may be omitted, for example, where the bounding box is originally determined with reference to a planting direction, or, potentially, where the candidate trials are generated based on actual planter passes through the field 102.

The agricultural computer system 114 then imposes, at 608, strips (e.g., synthetic planting passes, etc.) to the bounding box (i.e., the expanded bounding box) based on the interval of the trial. In this example, the strips are rectangular, and are imposed on the bounding box with the long axis of the rectangle in parallel with the long axis of the bounding box (if present). The strips, with a width consistent with the interval, are imposed from one edge of the bounding box to an opposite edge of the bounding box, so that the bounding box, in this example, is covered with the strips. For example, where a bounding box (expanded) is 1200 feet by 720 feet, and the interval is 30 feet, the agricultural computer system 114 may impose 24 strips 1200 feet long and 60 feet wide.

Next, the agricultural computer system 114 rotates, at 610, the bounding box consistent with, in this example, the general planting direction of the field 102. For example, the agricultural computer system 114 may align the planting direction for the field 102 with a long axis of the strips of the bounding box, and then rotate the bounding box. It should be appreciated that, as part of method 600, the agricultural computer system 114 may determine a planting direction, or estimate a planting direction when unknown for the field 102. For example, the planting direction may be estimated based on a harvest direction, or a shape of a field, or may be determined from imagery of the field 102 after planting, etc. Regardless, the bounding box is rotated to maintain a consistent planting direction in the strips imposed on the bounding box.

In addition, in the example method 600, the agricultural computer system 114 crops, at 612, the strips of the bounding box to the boundary line of the field 102, and more specifically, the headland 112a of the field 102 (and potentially to other headlands 112b-d of the field 102).

Specifically, in this example, the headland 112a of field 102 is accessed from the data server 110, or estimated when not included in the data in the data server 110. The headland 112a of the field 102 is then used to crop the strips to avoid overlap with the headland 112a. As a result, the edges of the strips may become contoured, or irregular, as compared to the original shape of the strip. In this example embodiment, the agricultural computer system 114 relies on the headland 112a proximate to and/or including the boundary line of the field 102, and omits headlands 112b-d isolated from the boundary line. As such, in this example, the headlands 112b-d are omitted from the determination in cropping the strips.

Once cropped, the strips for use in identifying trial locations within the field 102 are determined. That said, in this embodiment, because the strips are defined in a planar manner, while the field 102 is not (e.g., given the shape of the Earth, etc.), the agricultural computer system 114 may correct the strips for convergence. For example, the agricultural computer system 114 may transpose planting polygons on the same planar coordinate system on which the strips are located (or oriented, etc.). The agricultural computer system 114 may then compute an angle of the planting polygons on the planer coordinate system and rotate the strips (e.g., individually, in groups, etc.) to match the measured angle.

Alternatively in the method 600 (or additionally), one or more of the candidate trials may be generated, at 614, based on actual planter passes in the field 102, for instance, where the passes are generally continuous and not interrupted by headlands, etc. Here, the actual planter passes in the field 102 may be identified (e.g., from satellite imagery of the field 102 or otherwise, etc.) and used in lieu of or in place of (and instead of generating) the strips described above for the synthetic planter passes.

With further reference to FIG. 6, the agricultural computer system 114 then proceeds to generate, at 616, candidate trials from the cropped strips, based on either the synthetic planter passes generated for the field 102 or the actual planter passes in the field 102. To do so, the agricultural computer system 114 identifies, in this example embodiment, adjacent sets of three strips or passes (triplets) starting from an end strip (or pass) and working to an opposite end strip (or pass). For a cropped bounding box including 24 cropped strips (or synthetic passes), for example, the agricultural computer system 114 generates 22 candidate trials for the field 102, each having a unique location.

Then in the method 600, for each of the candidate trials, the agricultural computer system 114 filters the trials. In particular, in this example embodiment, the agricultural computer system 114 determines, at 618, a difference between a target yield for the control in the trial and a target yield for the test in the trial, and compares the difference to a threshold. The target yield may include a predicted yield for the test strips and control strips, or the target yield may include a potential yield for the test strips and control strips (e.g., based on the type of seeds in the candidate trials, field data, weather data, soil data, etc.). When the difference is above the threshold (or fails to satisfy the threshold), the candidate trial is discarded, at 620. Conversely, when the difference is below the threshold (or satisfies the threshold, at 618), the agricultural computer system 114 further determines, at 622, a sum of the grower seeding rate and the seeding threshold, and compares the sum to a treatment seeding rate (or, in other words, compares a difference between the grower seeding rate and the treatment seeding rate to a seeding threshold). When the sum is greater than the treatment seeding rate (or, alternatively, the difference in the seeding rates is greater than the threshold (or fails to satisfy the threshold)), the candidate trial is discarded, at 620. However, when the sum is greater than the threshold (at 622), the agricultural computer system 114 proceed to evaluate the target yields (or yield zones, etc.) of the candidate trials, in comparison of the target yield (or yield zones, etc.) of the field 102 in general.

In connection with evaluating the target yields (or yield zones, etc.) of the candidate trials and of the field 102, the agricultural computer system 114 determines, at 624, a target yield for each of the candidate trials and a target yield for the field 102 (e.g., yield zones therefore, etc.). This determination may include determining an actual yield (e.g., based on a harvest of crops from the field 102, etc.), or it may include determining a yield classification or zone of the candidate trial and field (e.g., a high yield zone, a medium yield zone, and a low yield zone, etc.) based on historical data for the field 102, satellite imagery data for the field 102, harvest data for the field 102, etc. The distribution of target yield for each candidate trial is then compared, at 626, to the distribution of target yield for the field 102, for example, via one or more statistical tests (e.g., the Kolmogorov-Smirnov test or statistic, etc.). And, the trials that are most similar to the rest of the field 102 may then be carried forward in the selection process (e.g., a desired number of trials having a smallest Kolmogorov—Smirnov statistic, trials having a Kolmogorov-Smirnov statistic satisfying a desired threshold, etc.).

For instance, when the distribution of target yields are insufficiently consistent, the candidate trial is discarded, at 620. Conversely, when the distribution of target yields are sufficiently consistent (e.g., based on the statistical analysis indicated above (e.g., based on the Kolmogorov—Smirnov test or statistic, etc.), etc.), the agricultural computer system 114 calculates, at 628, a combined shape and area metric for the given candidate trial as described above in the system 100, for example, via Equations (1)-(3).

The above is repeated for each of the candidate trials, until each is either discarded (at 620) or a combined shape and area metric is calculated. At 630, the remaining candidate trials (e.g., the candidate trials that are not discarded, etc.) are ranked according to the metric, and at 632, one or more of the candidate trials is selected, by the agricultural computer system 114, based on the metric and/or the rank relative to other candidate trials.

The agricultural computer system 114 may then publish the one or more selected candidate trials, for example, as the location for said trial in the target field 102 (e.g., to the grower 104, to other parties, etc.). And, the published trial(s), as made available to the grower, for example, may then be implemented in the target field 104 by the grower 104. For example, the grower 104 may plant seeds in the field 102 in accordance with one or more of the published candidate trial(s) (e.g., by planting seeds at the location(s) indicated by the candidate trial(s), treating the field 102 and/or seeds in accordance with the trial(s), harvesting the seeds in accordance with the trial(s), etc.), to promote improved accuracy in the trial, as to the target field 102 as a whole.

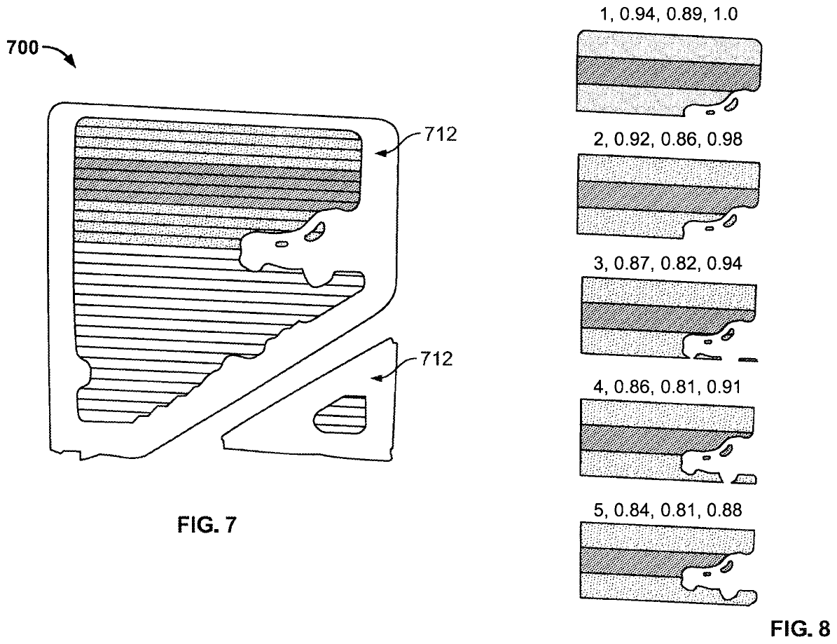

FIG. 7 illustrates another example target field 700, which includes headlands 712, and for which strips have been assigned through the above description of method 600. As shown in FIG. 8, then, several different candidate trials are illustrated, where the agricultural computer system 114 ranks the different candidate trials from 1-5 based on the combined shape and area metric (e.g., 0.94, 0.92, 0.87, 0.86, 0.84, etc.). As shown, the candidate trials in FIG. 8 are interrupted by the headlands in the target field 700, yet the metric provides an objective basis for the comparison of the different candidate trials. To this point, generally, the higher the combined shape and area metric, as described herein, the lower the yield deviation between the candidate trial and the target field 700.

It should be appreciated that the candidate trials, which are selected, may be validated and/or verified, for example, based on historical data. For example, as explained above, because an object of the candidate trial locations is to provide for an accurate understating of the effectiveness of the trial (e.g., whether the seed is better, or whether the treatment aided in yield, etc.), it may be desired to demonstrate similarity in the absence of the alteration of the trial. As such, upon selecting a candidate trial, in this example, the agricultural computer system 114 accesses prior planting and/or harvesting data for the field 102, for example, and compares the planting conditions for the strips of the triplet of the candidate trial and, assuming consistency, determines the standard deviation of the yield between the test and control strips of the trial, for example, using historical yield data on non-experimental fields. When the standard deviation is sufficiently low, the grower 104 may be confident in any difference between the control and the test, when the alteration of the trial is in fact implemented, it is the alteration that causes and/or substantially contributes to any difference in performance of the crop between the test and control strips in the trial.

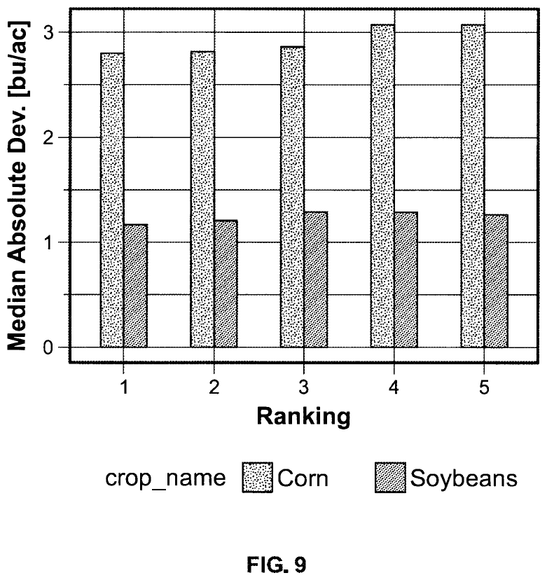

FIG. 9 illustrates an average of median absolute deviation in bushels per acre for a top five ranking candidate trials located, as described above, in more than 900 corn fields and more than 500 soybean fields. As illustrated, the median absolute deviation is sufficiently low to provide confidence that the candidate trial locations, as identified herein, are enhanced to provide an accurate representation of the fields in which the trials are located, as compared to conventional methods of locating trials in fields. In this manner, the method 600 may limit confounding factors for more accurate understanding of the alteration imposed with the trials (e.g., treatments, seeds, etc.).

With reference again to FIG. 1, the grower 104 in the system 100 may own, operate or possess a field manager computing device 116 in a field location, or associated with a field location, such as field 102, intended for agricultural activities or a management location for one or more agricultural fields. The field manager computing device 116 is programmed, or configured, to provide field data to the agricultural computer system 114 via one or more networks (as indicated by arrowed lines in FIG. 1) (e.g., for use in identifying characteristics of target field 102, for use in generating candidate trials for the field 102, etc.). The field manager computing device 116 is also programmed, or configured, to receive data from the agricultural computer system 114, for example, the published trial(s) described above (e.g., whereby the grower 104 may then implement one or more of the trial(s) in the field 104, etc.). The network(s) may each include, without limitation, one or more of a local area networks (LANs), wide area network (WANs) (e.g., the Internet, etc.), mobile/cellular networks, virtual networks, and/or another suitable public and/or private networks capable of supporting communication among parts of the system 100 illustrated in FIG. 1, or any combination thereof.

Examples of field data are provided above in connection with the description of the system 100. Additional examples may include, without limitation, (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) chemical application data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), (k) soil, seed, crop phenology, pest and disease reporting, and predictions sources and databases, and (l) other data described herein, etc.

As described, data server 110 is communicatively coupled to the agricultural computer system 114 and is programmed, or configured, to send external data (e.g., data associated with fields, etc.) to and/or receive other data from (e.g., published candidate trials for the field 102, etc.) agricultural computer system 114 via the network(s) herein (e.g., for use in identifying candidate seeds, treatments, etc. for the target field 102 identified by the grower 104; for use in implementing candidate trials in the field 102; etc.). The data server 110 may be owned or operated by the same legal person or entity as the agricultural computer system 114, or by a different person or entity, such as a government agency, non-governmental organization (NGO), and/or a private data service provider. Examples of external data include weather data, imagery data, soil data, seed data and seed selection data as described herein, data from the field 102, or statistical data relating to crop yields, among others. External data may include the same type of information as field data. In some embodiments, the external data may also be provided by data server 110 owned by the same entity that owns and/or operates the agricultural computer system 114. For example, the agricultural computer system 114 may include a data server focused exclusively on a type of data that might otherwise be obtained from third party sources, such as weather data. In some embodiments, data server 110 may actually be incorporated within the system 116.

The system 100 also includes, as described above, farm equipment (e.g., planter 106, harvester 108, a sprayer, etc.) configured to plant and harvest seeds from one or more growing spaces (e.g., from field 102, etc.) and provide treatments thereto, etc. In some examples, the farm equipment may have one or more remote sensors fixed thereon, where the sensor(s) are communicatively coupled, either directly or indirectly, via the farm equipment to the agricultural computer system 114 and are programmed, or configured, to send sensor data to agricultural computer system 114.

Notwithstanding the above, examples of agricultural apparatus that may be utilized in the system 100 (and in the field 102) include tractors, combines, other harvesters, planters, trucks, fertilizer equipment, aerial vehicles including unmanned aerial vehicles, and any other item of physical machinery or hardware, typically mobile machinery, and which may be used in tasks associated with agriculture and/or related to operations described herein. In some embodiments, a single unit of the agricultural apparatus may comprise a plurality of sensors that are coupled locally in a network on the apparatus. Controller area network (CAN) is an example of such a network that can be installed in combines, harvesters, sprayers, and cultivators. In connection therewith, then, an application controller associated with the apparatus may be communicatively coupled to agricultural computer system 114 via the network(s) and programmed, or configured, to receive one or more scripts that are used to control an operating parameter of the agricultural apparatus (or another agricultural vehicle or implement) from the agricultural computer system 114. For instance, a CAN bus interface may be used to enable communications from the agricultural computer system 114 to the agricultural apparatus, for example, such as how the CLIMATE FIELDVIEW DRIVE, available from The Climate Corporation, Saint Louis, Missouri, is used. Sensor data may consist of the same type of information as field data. In some embodiments, remote sensors may not be fixed to an agricultural apparatus but may be remotely located in the field and may communicate with one or more networks of the system 100.

As indicated above, the network(s) of the system 100 are generally illustrated in FIG. 1 by arrowed lines. In connection therewith, the network(s) broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. For instance, the farm equipment in the system 100, data server 110, agricultural computer system 114, and other elements of the system 100 may each comprise an interface compatible with the network(s) and programmed, or configured, to use standardized protocols for communication across the networks, such as TCP/IP, Bluetooth, CAN protocol and higher-layer protocols, such as HTTP, TLS, and the like.

Agricultural computer system 114 is programmed, or configured, to receive field data from field manager computing device 116, external data from data server 110, and sensor data from one or more remote sensors in the system 100, and also to provide data to the field manager computing device 116. Agricultural computer system 114 may be further configured to host, use or execute one or more computer programs, other software elements, digitally programmed logic, such as FPGAs or ASICs, or any combination thereof to perform translation and storage of data values, construction of digital models of one or more crops on one or more fields, generation of recommendations and notifications, and generation and sending of scripts, in the manner described further in other sections of this disclosure.

In an embodiment, as shown in FIG. 1, for example, agricultural computer system 114 is programmed with or comprises a communication layer 118, a presentation layer 120, a data management layer 124, a hardware/virtualization layer 126, and a model and field data repository 128. “Layer,” in this context, refers to any combination of electronic digital interface circuits, microcontrollers, firmware, such as drivers, and/or computer programs, or other software elements.

Communication layer 118 may be programmed, or configured, to perform input/output interfacing functions including sending requests to field manager computing device 116, data server 110, and remote sensor(s) for field data, external data, and sensor data respectively. Communication layer 118 may be programmed, or configured, to send the received data to repository layer 128 to be stored as field data (e.g., in computer system 114, etc.).

Presentation layer 120 may be programmed, or configured, to generate a graphical user interface (GUI) to be displayed on field manager computing device 116 (e.g., for use in interacting with agricultural computer system 114 to identify the target field 102, target seed, etc.) or other computers that are coupled to the system 114 through the network(s). The GUI may comprise controls for inputting data to be sent to agricultural computer system 114, generating requests for models and/or recommendations, and/or displaying recommendations, notifications, models, and other field data.

Data management layer 124 may be programmed, or configured, to manage read operations and write operations involving the repository layer 128 and other functional elements of the system, including queries and result sets communicated between the functional elements of the system and the repository. Examples of data management layer 124 include JDBC, SQL server interface code, and/or HADOOP interface code, among others. Repository layer 128 may comprise a database. As used herein, the term “database” may refer to either a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. However, any database may be used that enables the systems and methods described herein.

When field data is not provided directly to the agricultural computer system 114 via one or more agricultural machines or agricultural machine devices that interact with the agricultural computer system 114, the grower 104 may be prompted via one or more user interfaces on the device 116 (served by the agricultural computer system 114) to input such information for use in effecting the selections herein. In an example embodiment, the grower 104 may specify identification data by accessing a map on the device 116 (served by the agricultural computer system 114) and selecting specific CLUs that have been graphically shown on the map. In an alternative embodiment, the grower 104 may specify identification data by accessing a map on the device 116 (served by the agricultural computer system 114) and drawing boundaries of the field over the map. Such CLU selection, or map drawings, represent geographic identifiers. In alternative embodiments, the grower 104 may specify identification data by accessing field identification data (provided as shape files or in a similar format) from the U.S. Department of Agriculture Farm Service Agency, or other source, via the device 116 and providing such field identification data to the agricultural computer system 114.

In an example embodiment, the agricultural computer system 114 is programmed to generate and cause displaying of a graphical user interface comprising a data manager for data input. After one or more fields (and/or trials) have been identified using the methods described above, the data manager may provide one or more graphical user interface widgets which when selected can identify changes to the field, soil, crops, tillage, nutrient practices, locations, etc. and/or which may provide comparison data related to trials, target seed identified by the grower 104 and candidate seeds identified by the disclosure herein for the target field 102. The data manager may include a timeline view, a spreadsheet view, a graphical view, and/or one or more editable programs.

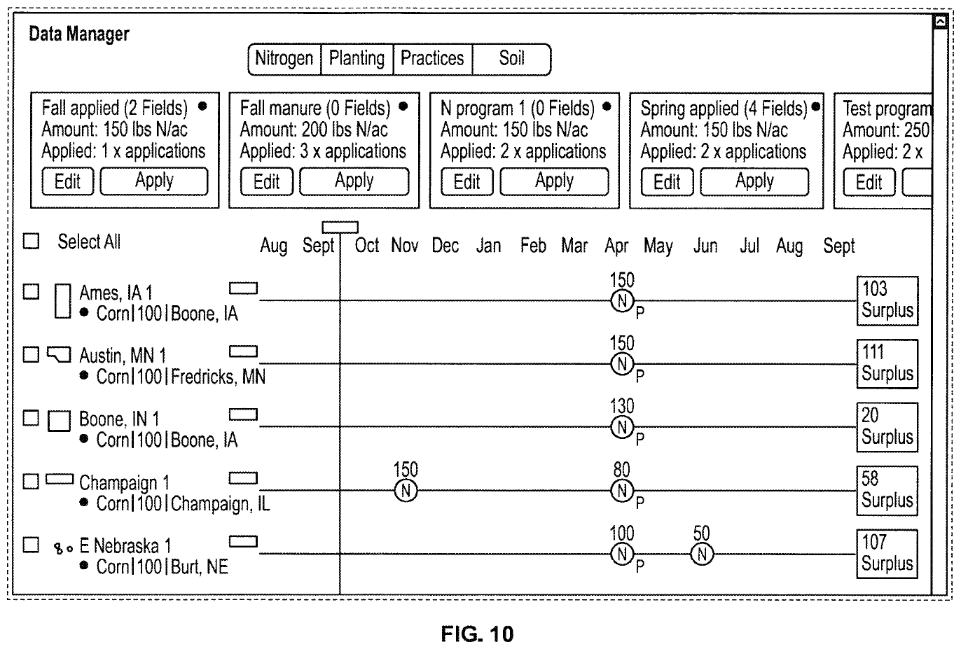

FIG. 10 depicts an example embodiment of a timeline view for data entry. Using the display depicted in FIG. 10, a user computer can input a selection of a particular field and a particular date for the addition of events (e.g., treatments, etc.). Events depicted at the top of the timeline may include Nitrogen, Planting, Practices, and Soil. To add a nitrogen application event, a user computer may provide input to select the nitrogen tab. The user computer may then select a location on the timeline for a particular field in order to indicate an application of nitrogen on the selected field. In response to receiving a selection of a location on the timeline for a particular field, the data manager may display a data entry overlay, allowing the user computer to input data pertaining to nitrogen applications, planting procedures, soil application, tillage procedures, irrigation practices, or other information relating to the particular field. For example, if a user computer selects a portion of the timeline and indicates an application of nitrogen, then the data entry overlay may include fields for inputting an amount of nitrogen applied, a date of application, a type of fertilizer used, and any other information related to the application of nitrogen.

In an embodiment, the data manager 124 provides an interface for creating one or more programs. “Program,” in this context, refers to a set of data pertaining to nitrogen applications, planting procedures, soil application, tillage procedures, irrigation practices, or other information that may be related to one or more fields, and that can be stored in digital data storage for reuse as a set in other operations. After a program has been created, it may be conceptually applied to one or more fields and references to the program may be stored in digital storage in association with data identifying the fields. Thus, instead of manually entering identical data relating to the same nitrogen applications for multiple different fields, a user computer may create a program that indicates a particular application of nitrogen and then apply the program to multiple different fields. For example, in the timeline view of FIG. 10, the top two timelines have the “Spring applied” program selected, which includes an application of 150 lbs N/ac in early April. The data manager may provide an interface for editing a program. In an embodiment, when a particular program is edited, each field that has selected the particular program is edited. For example, in FIG. 10, if the “Spring applied” program is edited to reduce the application of nitrogen to 116 lbs N/ac, the top two fields may be updated with a reduced application of nitrogen based on the edited program.

In an embodiment, in response to receiving edits to a field that has a program selected, the data manager removes the correspondence of the field to the selected program. For example, if a nitrogen application is added to the field in FIG. 10, the interface may update to indicate that the “Spring applied” program is no longer being applied to the top field. While the nitrogen application in early April may remain, updates to the “Spring applied” program would not alter the April application of nitrogen.

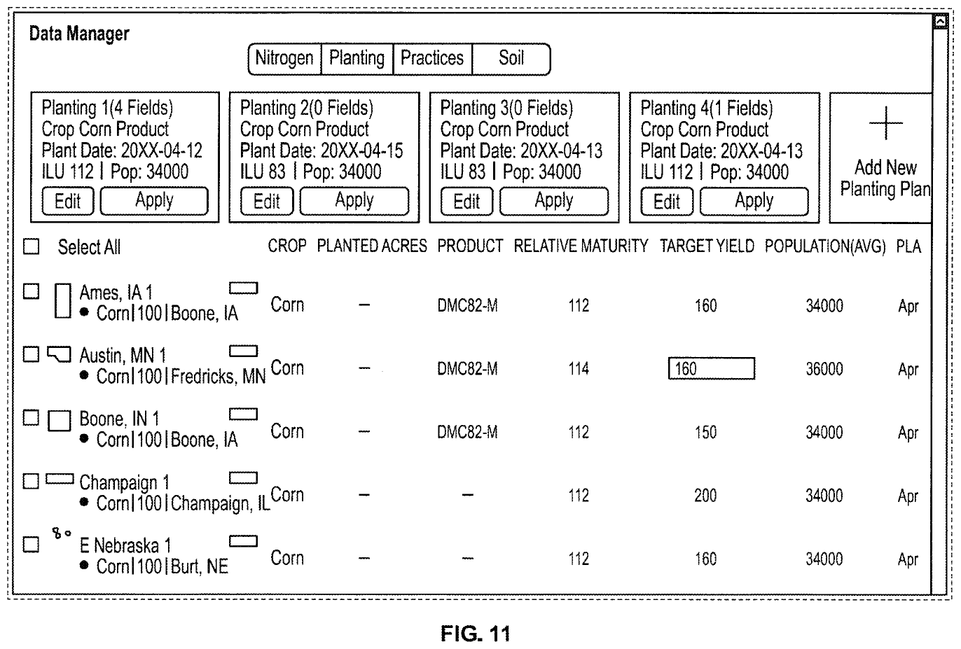

FIG. 11 depicts an example embodiment of a spreadsheet view for data entry. Using the display depicted in FIG. 11, a user can create and edit information for one or more fields. The data manager may include spreadsheets for inputting information with respect to Nitrogen, Planting, Practices, and Soil as depicted in FIG. 11. To edit a particular entry, a user computer may select the particular entry in the spreadsheet and update the values. For example, FIG. 11 depicts an in-progress update to a target yield value for the second field. Additionally, a user computer may select one or more fields in order to apply one or more programs. In response to receiving a selection of a program for a particular field, the data manager may automatically complete the entries for the particular field based on the selected program. As with the timeline view, the data manager may update the entries for each field associated with a particular program in response to receiving an update to the program. Additionally, the data manager may remove the correspondence of the selected program to the field in response to receiving an edit to one of the entries for the field.

In an embodiment, model and field data is stored in data repository layer 128. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

With reference again to FIG. 1, in an embodiment, instructions 122 of the agricultural computer system 114 may comprise a set of one or more pages of main memory, such as RAM, in the agricultural computer system 114 into which executable instructions have been loaded and which when executed cause the agricultural computer system 114 to perform the functions or operations that are described herein. For example, the instructions 122 may comprise a set of pages in RAM that contain instructions which, when executed, cause performing the seed identification functions described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, the instructions 122 also may represent one or more files or projects of source code that are digitally stored in a mass storage device, such as non-volatile RAM or disk storage, in the agricultural computer system 114 or a separate repository system, which when compiled or interpreted cause generating executable instructions which when executed cause the agricultural computer system 114 to perform the functions or operations that are described herein. In other words, the drawing figure may represent the manner in which programmers or software developers organize and arrange source code for later compilation into an executable, or interpretation into bytecode or the equivalent, for execution by the agricultural computer system 114.

Hardware/virtualization layer 126 comprises one or more central processing units (CPUs), memory controllers, and other devices, components, or elements of a computer system, such as volatile or non-volatile memory, non-volatile storage, such as disk, and I/O devices or interfaces as illustrated and described herein. The layer 126 also may comprise programmed instructions that are configured to support virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices 116 associated with different users. Further, the system 116 and/or data server 110 may be implemented using two or more processors, cores, clusters, or instances of physical machines or virtual machines, configured in a discrete location or co-located with other elements in a datacenter, shared computing facility or cloud computing facility.

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for disclosures of this type.

In an embodiment, grower 104 interacts with agricultural computer system 114 using field manager computing device 116 configured with an operating system and one or more application programs or apps; the field manager computing device 116 also may interoperate with the agricultural computer system 114 independently and automatically under program control or logical control and direct user interaction is not always required. Field manager computing device 116 broadly represents one or more of a smart phone, PDA, tablet computing device, laptop computer, desktop computer, workstation, or any other computing device capable of transmitting and receiving information and performing the functions described herein. Field manager computing device 116 may communicate via a network using a mobile application stored on field manager computing device 116, and in some embodiments, the device may be coupled using a cable or connector to one or more sensors and/or other apparatus in the system 100. A particular grower 104 may own, operate or possess and use, in connection with system 100, more than one field manager computing device 116 at a time.

The mobile application associated with the field manager computing device 116 may provide client-side functionality, via the network to one or more mobile computing devices. In an example embodiment, field manager computing device 116 may access the mobile application via a web browser or a local client application or app. Field manager computing device 116 may transmit data to, and receive data from, one or more front-end servers, using web-based protocols, or formats, such as HTTP, XML and/or JSON, or app-specific protocols. In an example embodiment, the data may take the form of requests and user information input, such as field data, into the mobile computing device. In some embodiments, the mobile application interacts with location tracking hardware and software on field manager computing device 116 which determines the location of field manager computing device 116 using standard tracking techniques, such as multilateration of radio signals, the global positioning system (GPS), WiFi positioning systems, or other methods of mobile positioning. In some cases, location data or other data associated with the device 116, grower 104, and/or user account(s) may be obtained by queries to an operating system of the device or by requesting an app on the device to obtain data from the operating system.

In an embodiment, in addition to other functionalities described herein, field manager computing device 116 sends field data (or other data) to agricultural computer system 114 comprising or including, but not limited to, data values representing one or more of: a geographical location of the one or more fields, tillage information for the one or more fields, crops planted in the one or more fields, and soil data extracted from the one or more fields. Field manager computing device 116 may send field data in response to user input from grower 104 specifying the data values for the one or more fields. Additionally, field manager computing device 116 may automatically send field data when one or more of the data values becomes available to field manager computing device 116. For example, field manager computing device 116 may be communicatively coupled to a remote sensor in the system 100, and in response to an input received at the sensor, field manager computing device 116 may send field data to agricultural computer system 114 representative of the input. Field data identified in this disclosure may be input and communicated using electronic digital data that is communicated between computing devices using parameterized URLs over HTTP, or another suitable communication or messaging protocol. In that sense, in some aspects of the present disclosure, the field data provided by the field manager computing device 116 may also be stored as external data (e.g., where the field data is collected as part of harvesting crops from the field 102, etc.), for example, in data server 110.

A commercial example of the mobile application is CLIMATE FIELDVIEW, commercially available from The Climate Corporation, Saint Louis, Missouri. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

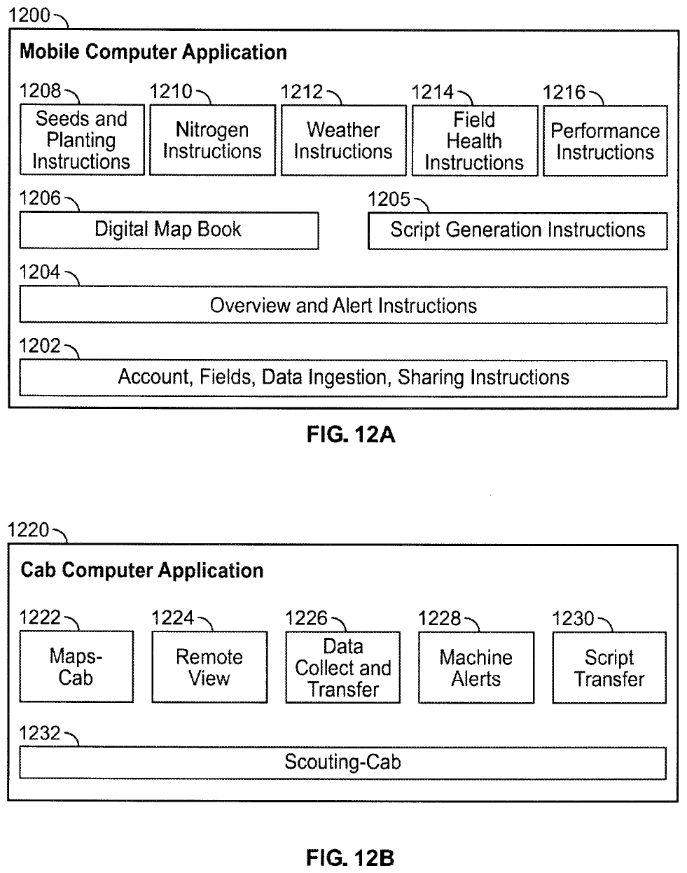

FIGS. 12A-12B illustrate two views of an example logical organization of sets of instructions in main memory when an example mobile application is loaded for execution. Each named element represents a region of one or more pages of RAM or other main memory, or one or more blocks of disk storage or other non-volatile storage, and the programmed instructions within those regions. In one embodiment, in FIG. 12A, a mobile computer application 1200 comprises account-fields-data ingestion-sharing instructions 1202, overview and alert instructions 1204, digital map book instructions 1206, seeds and planting instructions 1208, nitrogen instructions 1210, weather instructions 1212, field health instructions 1214, and performance instructions 1216.

In one embodiment, a mobile computer application 1200 comprises account, fields, data ingestion, sharing instructions 1202 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 1200 comprises a data inbox. In response to receiving a selection of the data inbox, the mobile computer application 1200 may display a graphical user interface for manually uploading data files and importing uploaded files to a data manager.

In one embodiment, digital map book instructions 1206 comprise field map data layers stored in device memory and are programmed with data visualization tools and geospatial field notes. This provides growers with convenient information close at hand for reference, logging and visual insights into field performance. In one embodiment, overview and alert instructions 1204 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 1208 are programmed to provide tools for seed selection, hybrid placement, and script creation, including variable rate (VR) script creation, based upon scientific models and empirical data. This enables growers to maximize yield or return on investment through optimized seed purchase, placement and population.

In one embodiment, script generation instructions 1205 are programmed to provide an interface for generating scripts, including variable rate (VR) fertility scripts. The interface enables growers to create scripts for field implements, such as nutrient applications, planting, and irrigation. For example, a planting script interface may comprise tools for identifying a type of seed for planting. Upon receiving a selection of the seed type, mobile computer application 1200 may display one or more fields broken into management zones, such as the field map data layers created as part of digital map book instructions 1206. In one embodiment, the management zones comprise soil zones along with a panel identifying each soil zone and a soil name, texture, drainage for each zone, or other field data. Mobile computer application 1200 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 1200 may make the script available for download in a format readable by an application controller, such as an archived or compressed format. Additionally, and/or alternatively, a script may be sent directly to a cab computer (e.g., associated with planter 106, harvester 108, etc.) from mobile computer application 1200 and/or uploaded to one or more data servers and stored for further use.

In one embodiment, nitrogen instructions 1210 are programmed to provide tools to inform nitrogen decisions by visualizing the availability of nitrogen to crops. This enables growers to maximize yield or return on investment through optimized nitrogen application during the season. Example programmed functions include displaying images, such as SSURGO images, to enable drawing of fertilizer application zones and/or images generated from subfield soil data, such as data obtained from sensors, at a high spatial resolution (as fine as millimeters or smaller depending on sensor proximity and resolution); upload of existing grower-defined zones; providing a graph of plant nutrient availability and/or a map to enable tuning application(s) of nitrogen across multiple zones; output of scripts to drive machinery; tools for mass data entry and adjustment; and/or maps for data visualization, among others. “Mass data entry,” in this context, may mean entering data once and then applying the same data to multiple fields and/or zones that have been defined in the system; example data may include nitrogen application data that is the same for many fields and/or zones of the same grower, but such mass data entry applies to the entry of any type of field data into the mobile computer application 1200. For example, nitrogen instructions 1210 may be programmed to accept definitions of nitrogen application and practices programs and to accept user input specifying to apply those programs across multiple fields. “Nitrogen application programs,” in this context, refers to stored, named sets of data that associates: a name, color code or other identifier, one or more dates of application, types of material or product for each of the dates and amounts, method of application or incorporation, such as injected or broadcast, and/or amounts or rates of application for each of the dates, crop or hybrid that is the subject of the application, among others. “Nitrogen practices programs,” in this context, refer to stored, named sets of data that associates: a practices name; a previous crop; a tillage system; a date of primarily tillage; one or more previous tillage systems that were used; one or more indicators of application type, such as manure, that were used. Nitrogen instructions 1210 also may be programmed to generate and cause displaying a nitrogen graph, which indicates projections of plant use of the specified nitrogen and whether a surplus or shortfall is predicted; in some embodiments, different color indicators may signal a magnitude of surplus or magnitude of shortfall. In one embodiment, a nitrogen graph comprises a graphical display in a computer display device comprising a plurality of rows, each row associated with and identifying a field; data specifying what crop is planted in the field, the field size, the field location, and a graphic representation of the field perimeter; in each row, a timeline by month with graphic indicators specifying each nitrogen application and amount at points correlated to month names; and numeric and/or colored indicators of surplus or shortfall, in which color indicates magnitude.

In one embodiment, the nitrogen graph may include one or more user input features, such as dials or slider bars, to dynamically change the nitrogen planting and practices programs so that a user may optimize his nitrogen graph. The user may then use his optimized nitrogen graph and the related nitrogen planting and practices programs to implement one or more scripts, including variable rate (VR) fertility scripts. Nitrogen instructions 1210 also may be programmed to generate and cause displaying a nitrogen map, which indicates projections of plant use of the specified nitrogen and whether a surplus or shortfall is predicted; in some embodiments, different color indicators may signal a magnitude of surplus or magnitude of shortfall. The nitrogen map may display projections of plant use of the specified nitrogen and whether a surplus or shortfall is predicted for different times in the past and the future (such as daily, weekly, monthly or yearly) using numeric and/or colored indicators of surplus or shortfall, in which color indicates magnitude. In one embodiment, the nitrogen map may include one or more user input features, such as dials or slider bars, to dynamically change the nitrogen planting and practices programs so that a user may optimize his nitrogen map, such as to obtain a preferred amount of surplus to shortfall. The user may then use his optimized nitrogen map and the related nitrogen planting and practices programs to implement one or more scripts, including variable rate (VR) fertility scripts. In other embodiments, similar instructions to the nitrogen instructions 1210 could be used for application of other nutrients (such as phosphorus and potassium), application of pesticide, and irrigation programs.

In one embodiment, weather instructions 1212 are programmed to provide field-specific recent weather data and forecasted weather information. This enables growers to save time and have an efficient integrated display with respect to daily operational decisions.

In one embodiment, field health instructions 1214 are programmed to provide timely remote sensing images highlighting in-season crop variation and potential concerns. Example programmed functions include cloud checking, to identify possible clouds or cloud shadows; determining nitrogen indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 1216 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 1216 may be programmed to communicate via the network(s) to back-end analytics programs executed at agricultural computer system 114 and/or data server 110 and configured to analyze metrics, such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of a cab computer (e.g., associated with planter 106, harvester 108, etc.). For example, referring now to FIG. 12B, in one embodiment a cab computer application 1220 (e.g., as accessible in planter 106, harvester 108, etc., etc.) may comprise maps-cab instructions 1222, remote view instructions 1224, data collect and transfer instructions 1226, machine alerts instructions 1228, script transfer instructions 1230, and scouting-cab instructions 1232. The code base for the instructions of FIG. 12B may be the same as for FIG. 12A and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 1222 may be programmed to provide map views of fields, farms or regions that are useful in directing machine operation. The remote view instructions 1224 may be programmed to turn on, manage, and provide views of machine activity in real-time or near real-time to other computing devices connected to the computer system 114 via wireless networks, wired connectors or adapters, and the like. The data collect and transfer instructions 1226 may be programmed to turn on, manage, and provide transfer of data collected at sensors and controllers to the computer system 114 via wireless networks, wired connectors or adapters, and the like (e.g., via network(s) in the system 100, etc.). The machine alerts instructions 1228 may be programmed to detect issues with operations of the machine or tools that are associated with the cab and generate operator alerts. The script transfer instructions 1130 may be configured to transfer in scripts of instructions that are configured to direct machine operations or the collection of data. The scouting-cab instructions 1232 may be programmed to display location-based alerts and information received from the computer system 114 based on the location of the field manager computing device 116, farm equipment, or sensors in the field 102 and ingest, manage, and provide transfer of location-based scouting observations to the computer system 114 based on the location of the farm equipment or sensors in the field 102.

In an embodiment, data server 110 stores external data, including soil data representing soil composition for the one or more fields and weather data representing temperature and precipitation on the one or more fields. The weather data may include past and present weather data as well as forecasts for future weather data. In an embodiment, data server 110 comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil. Further, in some embodiments, the data server 110, again, may include data associated with the field 102 with regard to available seeds for use in comparisons, etc.

In an embodiment, remote sensors in the system 100 may comprises one or more sensors that are programmed, or configured, to produce one or more observations. Remote sensor may be aerial sensors, such as satellites, vehicle sensors, planting equipment sensors, tillage sensors, fertilizer or insecticide application sensors, harvester sensors, and any other implement capable of receiving data from the one or more fields (e.g., field 102, etc.). In an embodiment, farm equipment may include an application controller programmed, or configured, to receive instructions from agricultural computer system 114. The application controller may also be programmed, or configured, to control an operating parameter of the farm equipment. Other embodiments may use any combination of sensors and controllers, of which the following are merely selected examples.

The system 100 may obtain or ingest data under grower 104 control, on a mass basis from a large number of growers who have contributed data to a shared database system. This form of obtaining data may be termed “manual data ingest” as one or more user-controlled computer operations are requested, or triggered, to obtain data for use by the computer system 114. As an example, the CLIMATE FIELDVIEW application, commercially available from The Climate Corporation, Saint Louis, Missouri, may be operated to export data to computer system 114 for storing in the repository layer 128.

For example, seed monitor systems can both control planter apparatus components and obtain planting data, including signals from seed sensors via a signal harness that comprises a CAN backbone and point-to-point connections for registration and/or diagnostics. Seed monitor systems can be programmed, or configured, to display seed spacing, population and other information to the user via a cab computer of the apparatus, or other devices within the system 100. Examples are disclosed in U.S. Pat. No. 8,738,243 and US Pat. Pub. 20126094916, and the present disclosure assumes knowledge of those other patent disclosures.

Likewise, yield monitor systems may contain yield sensors for harvester apparatus that send yield measurement data to a cab computer of the apparatus, or other devices within the system 100. Yield monitor systems may utilize one or more remote sensors to obtain grain moisture measurements in a combine, or other harvester, and transmit these measurements to the user via the cab computer, or other devices within the system 100.

In an embodiment, examples of sensors that may be used with any moving vehicle, or apparatus of the type described elsewhere herein, include kinematic sensors and position sensors. Kinematic sensors may comprise any of speed sensors, such as radar or wheel speed sensors, accelerometers, or gyros. Position sensors may comprise GPS receivers or transceivers, or WiFi-based position or mapping apps that are programmed to determine location based upon nearby WiFi hotspots, among others.

In an embodiment, examples of sensors that may be used with tractors, or other moving vehicles, include engine speed sensors, fuel consumption sensors, area counters or distance counters that interact with GPS or radar signals, PTO (power take-off) speed sensors, tractor hydraulics sensors configured to detect hydraulics parameters, such as pressure or flow, and/or and hydraulic pump speed, wheel speed sensors or wheel slippage sensors. In an embodiment, examples of controllers that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors that may be used with seed planting equipment, such as planters, drills, or air seeders include seed sensors, which may be optical, electromagnetic, or impact sensors; downforce sensors, such as load pins, load cells, pressure sensors; soil property sensors, such as reflectivity sensors, moisture sensors, electrical conductivity sensors, optical residue sensors, or temperature sensors; component operating criteria sensors, such as planting depth sensors, downforce cylinder pressure sensors, seed disc speed sensors, seed drive motor encoders, seed conveyor system speed sensors, or vacuum level sensors; or pesticide application sensors, such as optical or other electromagnetic sensors, or impact sensors. In an embodiment, examples of controllers that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors that may be used with tillage equipment include position sensors for tools, such as shanks or discs; tool position sensors for such tools that are configured to detect depth, gang angle, or lateral spacing; downforce sensors; or draft force sensors. In an embodiment, examples of controllers that may be used with tillage equipment include downforce controllers or tool position controllers, such as controllers configured to control tool depth, gang angle, or lateral spacing.

In an embodiment, examples of sensors that may be used in relation to apparatus for applying fertilizer, insecticide, fungicide and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors, such as accelerometers disposed on sprayer booms. In an embodiment, examples of controllers that may be used with such apparatus include pump speed controllers; valve controllers that are programmed to control pressure, flow, direction, PWM and the like; or position actuators, such as for boom height, subsoiler depth, or boom position.

In an embodiment, examples of sensors that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors, such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers that may be used with harvesters include header operating criteria controllers for elements, such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors that may be used with grain carts include weight sensors, or sensors for auger position, operation, or speed. In an embodiment, examples of controllers that may be used with grain carts include controllers for auger position, operation, or speed.

In an embodiment, examples of sensors and controllers may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus; other electromagnetic radiation emitters and reflected electromagnetic radiation detection apparatus. Such controllers may include guidance or motor control apparatus, control surface controllers, camera controllers, or controllers programmed to turn on, operate, obtain data from, manage and configure any of the foregoing sensors. Examples are disclosed in U.S. patent application Ser.. No. 14/831,165 and the present disclosure assumes knowledge of that other patent disclosures.

In an embodiment, sensors and controllers may be affixed to soil sampling and measurement apparatus that is configured, or programmed, to sample soil and perform soil chemistry tests, soil moisture tests, and other tests pertaining to soil. For example, the apparatus disclosed in U.S. Pat. Nos. 8,767,194 and 8,712,148 may be used, and the present disclosure assumes knowledge of those patent disclosures.

In an embodiment, sensors and controllers may comprise weather devices for monitoring weather conditions of fields. For example, the apparatus disclosed in published international application WO2016/176355A1, may be used, and the present disclosure assumes knowledge of that patent disclosure.

In an embodiment, the agricultural computer system 114 is programmed, or configured, to create an agronomic model. In this context, an agronomic model is a data structure in memory of the agricultural computer system 114 that comprises field data, such as identification data and harvest data for one or more fields. The agronomic model may also comprise calculated agronomic properties which describe either conditions which may affect the growth of one or more crops on a field, or properties of the one or more crops, or both. Additionally, an agronomic model may comprise recommendations based on agronomic factors, such as crop recommendations, irrigation recommendations, planting recommendations, fertilizer recommendations, fungicide recommendations, pesticide recommendations, harvesting recommendations and other crop management recommendations. The agronomic factors may also be used to estimate one or more crop related results, such as agronomic yield. The agronomic yield of a crop is an estimate of quantity of the crop that is produced, or in some examples, the revenue or profit obtained from the produced crop.

In an embodiment, the agricultural computer system 114 may use a preconfigured agronomic model to calculate agronomic properties related to currently received location and crop information for one or more fields. The preconfigured agronomic model is based upon previously processed field data, including but not limited to, identification data, harvest data, fertilizer data, and weather data. The preconfigured agronomic model may have been cross validated to ensure accuracy of the model. Cross validation may include comparison to ground truthing that compares predicted results with actual results on a field, such as a comparison of precipitation estimate with a rain gauge or sensor providing weather data at the same or nearby location or an estimate of nitrogen content with a soil sample measurement.

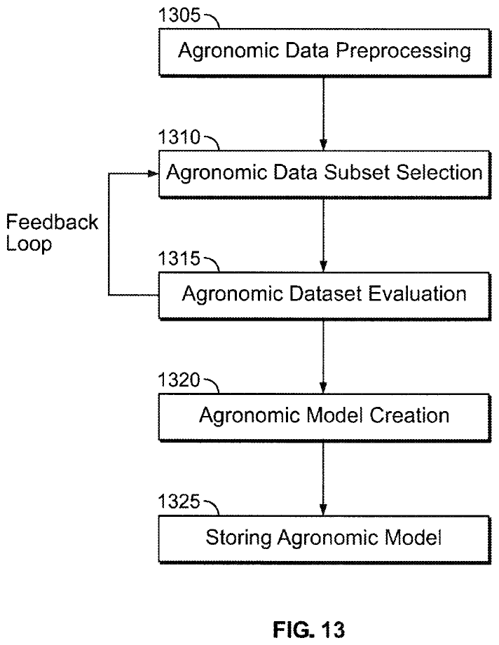

FIG. 13 illustrates a programmed process by which the agricultural computer system 114 generates one or more preconfigured agronomic models using field data provided by one or more data sources. FIG. 13 may serve as an algorithm or instructions for programming the functional elements of the agricultural computer system 114 to perform the operations that are now described.

At block 1305, the agricultural computer system 114 is configured, or programmed, to implement agronomic data preprocessing of field data received from one or more data sources. The field data received from one or more data sources may be preprocessed for the purpose of removing noise, distorting effects, and confounding factors within the agronomic data including measured outliers that could adversely affect received field data values. Embodiments of agronomic data preprocessing may include, but are not limited to, removing data values commonly associated with outlier data values, specific measured data points that are known to unnecessarily skew other data values, data smoothing, aggregation, or sampling techniques used to remove or reduce additive or multiplicative effects from noise, and other filtering or data derivation techniques used to provide clear distinctions between positive and negative data inputs.

At block 1310, the agricultural computer system 114 is configured, or programmed, to perform data subset selection using the preprocessed field data in order to identify datasets useful for initial agronomic model generation. The agricultural computer system 114 may implement data subset selection techniques including, but not limited to, a genetic algorithm method, an all subset models method, a sequential search method, a stepwise regression method, a particle swarm optimization method, and an ant colony optimization method. For example, a genetic algorithm selection technique uses an adaptive heuristic search algorithm, based on evolutionary principles of natural selection and genetics, to determine and evaluate datasets within the preprocessed agronomic data.

At block 1315, the agricultural computer system 114 is configured, or programmed, to implement field dataset evaluation. In an embodiment, a specific field dataset is evaluated by creating an agronomic model and using specific quality thresholds for the created agronomic model. Agronomic models may be compared and/or validated using one or more comparison techniques, such as, but not limited to, root mean square error with leave-one-out cross validation (RMSECV), mean absolute error, and mean percentage error. For example, RMSECV can cross validate agronomic models by comparing predicted agronomic property values created by the agronomic model against historical agronomic property values collected and analyzed. In an embodiment, the agronomic dataset evaluation logic is used as a feedback loop where agronomic datasets that do not meet configured quality thresholds are used during future data subset selection steps (block 1310).

At block 1320, the agricultural computer system 114 is configured, or programmed, to implement agronomic model creation based upon the cross validated agronomic datasets. In an embodiment, agronomic model creation may implement multivariate regression techniques to create preconfigured agronomic data models.

At block 1325, the agricultural computer system 114 is configured, or programmed, to store the preconfigured agronomic data models for future field data evaluation.

According to one embodiment, the techniques described herein are implemented by one or more special-purpose computing devices. The special-purpose computing devices may be hard-wired to perform the techniques, or may include digital electronic devices, such as one or more application-specific integrated circuits (ASICs) or field programmable gate arrays (FPGAs), that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

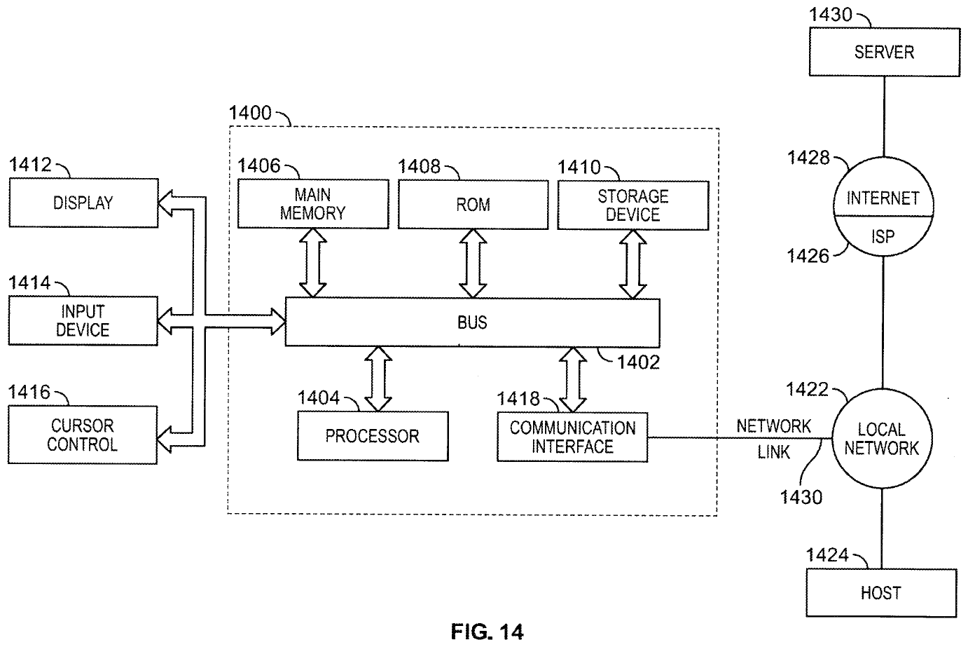

For example, FIG. 14 is a block diagram that illustrates a computer system 1400 upon which embodiments of the present disclosure may be implemented. Computer system 1400 includes a bus 1402 or other communication mechanism for communicating information, and a hardware processor 1404 coupled with bus 1402 for processing information. Hardware processor 1404 may be, for example, a general purpose microprocessor.

Computer system 1400 also includes a main memory 1406, such as a random access memory (RAM) or other dynamic storage device, coupled to bus 1402 for storing information and instructions to be executed by processor 1404. Main memory 1406 also may be used for storing temporary variables or other intermediate information during execution of instructions to be executed by processor 1404. Such instructions, when stored in non-transitory storage media accessible to processor 1404, render computer system 1400 into a special-purpose machine that is customized to perform the operations specified in the instructions.

Computer system 1400 further includes a read only memory (ROM) 1408, or other static storage device coupled to bus 1402, for storing static information and instructions for processor 1404. A storage device 1410, such as a magnetic disk, optical disk, or solid-state drive, is provided and coupled to bus 1402 for storing information and instructions.

Computer system 1400 may be coupled via bus 1402 to a display 1412, such as a cathode ray tube (CRT), for displaying information to a computer user. An input device 1414, including alphanumeric and other keys, is coupled to bus 1402 for communicating information and command selections to processor 1404. Another type of user input device is cursor control 1416, such as a mouse, a trackball, or cursor direction keys for communicating direction information and command selections to processor 1404 and for controlling cursor movement on display 1412. This input device typically has two degrees of freedom in two axes, a first axis (e.g., x, etc.) and a second axis (e.g., y, etc.), that allows the device to specify positions in a plane.

Computer system 1400 may implement the techniques described herein using customized hard-wired logic, one or more ASICs or FPGAs, firmware and/or program logic which in combination with the computer system causes or programs computer system 1400 to be a special-purpose machine. According to one embodiment, the techniques herein are performed by computer system 1400 in response to processor 1404 executing one or more sequences of one or more instructions contained in main memory 1406. Such instructions may be read into main memory 1406 from another storage medium, such as storage device 1410. Execution of the sequences of instructions contained in main memory 1406 causes processor 1404 to perform the process steps described herein. In alternative embodiments, hard-wired circuitry may be used in place of, or in combination with, software instructions.

The term “storage media” as used herein refers to any non-transitory media that stores data and/or instructions that cause a machine to operate in a specific fashion. Such storage media may comprise non-volatile media and/or volatile media. Non-volatile media includes, for example, optical disks, magnetic disks, or solid-state drives, such as storage device 1410. Volatile media includes dynamic memory, such as main memory 1406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from, but may be used in conjunction with, transmission media. Transmission media participates in transferring information between storage media. For example, transmission media includes coaxial cables, copper wire and fiber optics, including the wires that comprise bus 1402. Transmission media can also take the form of acoustic or light waves, such as those generated during radio-wave and infrared data communications.

Various forms of media may be involved in carrying one or more sequences of one or more instructions to processor 1404 for execution. For example, the instructions may initially be carried on a magnetic disk or solid-state drive of a remote computer. The remote computer can load the instructions into its dynamic memory and send the instructions over a telephone line using a modem. A modem local to computer system 1400 can receive the data on the telephone line and use an infra-red transmitter to convert the data to an infra-red signal. An infra-red detector can receive the data carried in the infrared signal and appropriate circuitry can place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card, cable modem, satellite modem, or a modem to provide a data communication connection to a corresponding type of telephone line. As another example, communication interface 1418 may be a local area network (LAN) card to provide a data communication connection to a compatible LAN. Wireless links may also be implemented. In any such implementation, communication interface 1418 sends and receives electrical, electromagnetic or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426 in turn provides data communication services through the world wide packet data communication network now commonly referred to as the “Internet” 1428. Local network 1422 and Internet 1428 both use electrical, electromagnetic or optical signals that carry digital data streams. The signals through the various networks and the signals on network link 1420 and through communication interface 1418, which carry the digital data to and from computer system 1400, are example forms of transmission media.

Computer system 1400 can send messages and receive data, including program code, through the network(s), network link 1420 and communication interface 1418. In the Internet example, a server might transmit a requested code for an application program through Internet 1428, ISP 1426, local network 1422 and communication interface 1418.

The received code may be executed by processor 1404 as it is received, and/or stored in storage device 1410, or other non-volatile storage for later execution.

In view of the above, the systems and methods herein provide for locating trials (e.g., identifying locations of the trials, sizes of the trials, field locations for experimental placement of trials based on prediction models, etc.) in fields to improve accuracy and consistency of the trials, as indicative of performance of one ore more intentional variations defining the trials, generally, in the fields (e.g., and not environmental conditions, field conditions, etc.). In doing so, the systems and methods operate to identify an area (or areas) in the fields, for example, that are sufficient in or have a desired size, shape, composition, etc. and that have (or exhibit) desired environmental factors to support the trials. As such, the present disclosure may provide for improved accuracy of trials in target fields, for example, by limiting or eliminating contributing variations (beyond the one or more intention trial variations) in the target fields. This allows the trial(s) to have similar pre-treatment conditions, which in turn allows for more accurate measurement (and/or isolation) of the effect of the intentional variation(s) on the specific yield of the seeds or other performance metric of the trial in the target field. Further, the above technical effects may be achieved in regions irrelevant of data quality in the regions (e.g., through use of the synthetic passes described herein for regions with low-quality data, etc.).

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) accessing, for a target field, from a data server, a boundary line for the target field and an interval for planting passes for a trial in the target field; (b) defining a bounding box for the field based on the boundary line of the field, whereby the bounding box extends around the boundary line; (c) imposing multiple strips to the bounding box, each strip having a dimension consistent with the planting passes for the trial in the target field; (d) rotating the bounding box, with the strips, to an orientation consistent with a planting direction of the target field; (e) cropping the multiple strips consistent with one or more headlands of the target field; (f) generating multiple candidate trials for the target field, including multiple consecutive ones of the multiple strips; (g) calculating, for each of the candidate trials, a metric based on one or more areas of said candidate trial; and (h) selecting and publishing one or more of the candidate trials, based on the metric, thereby identifying the one or more of the candidate trials as the location for said trial in the target field.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1 - 2, 2-10, 2- 8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for use in identifying a location and/or a size of a trial in a target field, the method comprising:
accessing, by a computing device, for a target field, from a data server, a boundary line for the target field and an interval for planting passes for a trial in the target field;
defining, by the computing device, a bounding box for the field based on the boundary line of the field, whereby the bounding box extends around the boundary line;
imposing, by the computing device, multiple strips to the bounding box, each strip having a dimension consistent with the planting passes for the trial in the target field;
rotating, by the computing device, the bounding box, with the strips, to an orientation consistent with a planting direction of the target field;
cropping, by the computing device, the multiple strips consistent with one or more headlands of the target field;
generating, by the computing device, multiple candidate trials for the target field, including multiple consecutive ones of the multiple strips;
calculating, by the computing device, for each of the candidate trials, a metric based on one or more areas of said candidate trial; and
selecting and publishing, by the computing device, one or more of the candidate trials, based on the metric, thereby identifying the one or more of the candidate trials as the location for said trial in the target field.

2. The method of claim 1, further comprising accessing the planting direction, from a data server, prior to rotating the bounding box to the orientation consistent with the planting direction.

3. The method of claim 2, further comprising expanding the bounding box, prior to imposing the multiple strips to the bounding box.

4. The method of claim 3, wherein the dimension of each of the strips is equal to the interval; or
wherein the dimension of each of the strips is equal to a multiple of the interval.

5. The method of claim 4, further comprising:
for each of the candidate trials:
determining a difference between a yield of a test segment of the candidate trial and a yield of a control segment of the candidate trial; and
discarding the candidate trial in response to the difference failing to satisfy a defined threshold; and
wherein calculating the metric for each of the candidate trials includes calculating the metric for each of the un-discarded candidate trials.

6. The method of claim 5, wherein the yield of the test segment is a predicted yield of the test segment or a potential yield of the test segment; and
wherein the yield of the control segment is a predicted yield of the control segment or a potential yield of the control segment.

7. The method of claim 6, further comprising:
for each candidate trial:
determining a sum of a grower seeding rate and a defined seeding threshold; and
discarding the candidate trial in response to the sum failing to satisfy a defined treatment seeding rate.

8. The method of claim 7, further comprising:
for each candidate trial:
determining a yield profile of the candidate trial; and
discarding the candidate trial in response to the yield profile of the candidate trial being insufficiently consistent with a yield profile of the target field.

9. The method of claim 1, wherein the metric is defined by:
$$Metric = \frac{2 \times ( RAR \times SR )}{( RAR + SR )} ;$$
wherein a shape ratio (SR) is defined by:
$$ShapeRatio ( SR ) = \frac{{TrialArea}_{i}}{TrialBox {Area}_{i}} ;$$
and
wherein a relative area ratio (RAR) is defined by:
$$RelativeAreaRatio ( RAR ) = \frac{{RelativeArea}_{i}}{max ( {RelativeArea}_{i} )} ,$$
wherein:
RelativeAreaᵢ=CntAreaᵢ+0.5·TrtAreaᵢ.

10. The method of claim 1, wherein rotating the bounding box includes determining the planting direction of the target field from an image of the target field.

11. The method of claim 1, further comprising, planting the trial in the target field at a location defined by the candidate trial.

12. A system for use in identifying a location and/or a size of a trial in a target field, the system comprising an agricultural computer system configured to:
access, for a target field, from a data server, a boundary line for the target field and an interval for planting passes for a trial in the target field;
define a bounding box for the field based on the boundary line of the field, whereby the bounding box extends around the boundary line;
impose multiple strips to the bounding box, each strip having a dimension consistent with the planting passes for the trial in the target field;
rotate the bounding box, with the strips, to an orientation consistent with a planting direction of the target field;
crop the multiple strips consistent with one or more headlands of the target field,
generate multiple candidate trials for the target field, including multiple consecutive ones of the multiple strips;
calculate, for each of the candidate trials, a metric based on one or more areas of said candidate trial; and
select and publish one or more of the candidate trials, based on the metric, thereby identifying the one or more of the candidate trials as the location for said trial in the target field.

13. The system of claim 12, wherein the agricultural computer system is further configured to expand the bounding box, prior to imposing the multiple strips to the bounding box.

14. The system of claim 12, wherein the agricultural computer system is further configured, for each of the candidate trials, to:
determine a difference between a yield of a test segment of the candidate trial and a yield of a control segment of the candidate trial; and
discard the candidate trial in response to the difference failing to satisfy a defined threshold;
wherein the agricultural computer system is configured, in connection with calculating the metric for each of the candidate trials, to calculate the metric for each of the un-discarded candidate trials.

15. The system of claim 12, wherein the agricultural computer system is configured, for each candidate trial, to:
determine a sum of a grower seeding rate and a defined seeding threshold; and
discard the candidate trial in response to the sum failing to satisfy a defined treatment seeding rate.

16. The system of claim 12, wherein the agricultural computer system is configured, for each candidate trial, to:
determine a yield profile of the candidate trial; and
discard the candidate trial in response to the yield profile of the candidate trial being insufficiently consistent with a yield profile of the target field.

17. The system of claim 12, wherein the metric is defined by:
$$Metric = \frac{2 \times ( RAR \times SR )}{( RAR + SR )} ;$$
wherein a shape ratio (SR) is defined by:
$$ShapeRatio ( SR ) = \frac{{TrialArea}_{i}}{TrialBox {Area}_{i}} ;$$
and
wherein a relative area ratio (RAR) is defined by:
$$RelativeAreaRatio ( RAR ) = \frac{{RelativeArea}_{i}}{max ( {RelativeArea}_{i} )} ,$$
wherein:
RelativeAreaᵢ=CntAreaᵢ+0.5·TrtAreaᵢ.

18. The system of claim 12, further comprising a farming machine configured to plant the trial in the target field at a location defined by the candidate trial.

19. The system of claim 12, further comprising a non-transitory computer-readable storage medium comprising executable instructions, which when executed by at least one processor of a field manager computing device, cause the at least one processor to display the one or more of the candidate trials to a grower associated with the target field.

20. A non-transitory computer-readable storage medium comprising executable instructions, which when executed by at least one processor of an agricultural computer system in connection with identifying a location and/or a size of a trial in a target field, cause the at least one processor to:
access, for a target field, from a data server, a boundary line for the target field and an interval for planting passes for a trial in the target field;
define a bounding box for the field based on the boundary line of the field, whereby the bounding box extends around the boundary line;
impose multiple strips to the bounding box, each strip having a dimension consistent with the planting passes for the trial in the target field;
rotate the bounding box, with the strips, to an orientation consistent with a planting direction of the target field;
crop the multiple strips consistent with one or more headlands of the target field,
generate multiple candidate trials for the target field, including multiple consecutive ones of the multiple strips;
calculate, for each of the candidate trials, a metric based on one or more areas of said candidate trial; and
select and publish one or more of the candidate trials, based on the metric, thereby identifying the one or more of the candidate trials as the location for said trial in the target field.
